(19) United States
(12) Patent Application Publication
(10) Pub. No.: US 2013/0232439 A1
(43) Pub. Date: Sep. 5, 2013

(54) METHOD AND APPARATUS FOR TURNING PAGES IN TERMINAL

(71) Applicant: SAMSUNG ELECTRONICS CO., LTD., Suwon-si (KR)

(72) Inventors: Shinjun LEE, Yongin-si (KR); Sanghyup LEE, Suwon-si (KR); Amir DROR, Tel Aviv (IL); Kyungsoo HONG, Netanya (IL); Ofir ENGOLZ, Kfar Saba (IL); Youngri KIM, Suwon-si (KR); Ilhwan KIM, Seoul (KR); Juyoun LEE, Seongnam-si (KR)

(73) Assignee: SAMSUNG ELECTRONICS CO., LTD., Suwon-si (KR)

(21) Appl. No.: 13/782,170

(22) Filed: Mar. 1, 2013

(30) Foreign Application Priority Data
Mar. 2, 2012 (KR) 10-2012-0021922

(51) Int. Cl. G06F 3/0488

(52) U.S. Cl. CPC G06F 3/0488
USPC 715/776

(57) ABSTRACT

Provided are a method for turning pages in a terminal including an electronic book reader function for turning pages according to user input information associated with pages and an apparatus thereof. The method of turning pages in a portable terminal having a touch screen includes: displaying a page of an electronic book on the touch screen; detecting a touch in a first corner region of the page of the electronic book; changing the first corner region into a second corner region in response to the touch; detecting a continuous motion of the touch in the second corner region; and turning the displayed page in response to the continuous motion of the touch.

### PRIORITY

This application claims the benefit under 35 U.S.C. §119(a) of Korean Patent Application No. 10-2012-0021922, filed on Mar. 2, 2012 in the Korean Intellectual Property Office, the entire disclosure of which is hereby incorporated by reference.

### BACKGROUND

1. Field

Methods and apparatuses consistent with exemplary embodiments relate to turning pages in a terminal including an electronic book reader function, and more particularly, to turning pages according to user input information associated with pages.

2. Description of the Related Art

In general, an electronic book generally refers to a digital book which allows a user to view it as a book by recording information such as text or images in an electronic medium. The user may view an electronic book which is displayed using a terminal including an electronic book reader function. For example, the user may conveniently purchase and read a desired electronic book anytime and anywhere using a smart phone or a tablet personal computer (PC). Accordingly, use of electronic books has grown in popularity.

In general, the terminal turns pages of an electronic book according to input information of the user. However, the page turning is very simple. That is, according to a method and an apparatus for turning pages according to the related art, it is difficult to provide the user with the feeling of turning pages in a fashion which is similar to turning actual pages of a book. When input information of the user associated with page turning, for example, pushing of a button to turn to a next page, is detected, the method and apparatus for turning pages according to the related art replaces a currently displayed page by a next page. Such a replacement scheme simply browses a web page rather than actually turning pages. Further, terminals may include a touch screen.

The terminal with a touch screen detects a user gesture during displaying an optional page and provides animation whose page is turned in response to the detected user gesture. That is, a terminal using a touch screen may provide a feeling to the user of actually turning a paper page as the user directly operates the page. However, the animation provided by a conventional terminal is insufficient to achieve a feeling of turning the pages of an actual paper book.

### SUMMARY

One or more exemplary embodiments provide a method of turning pages which enables a user to achieve a feeling of reading a paper book when the user reads an electronic book, and an apparatus thereof.

One or more exemplary embodiments also provide an animation in which a plurality of pages is turned.

In accordance with an aspect of an exemplary embodiment, there is provide a method of turning pages in a portable terminal having a touch screen, the method including: displaying a page of an electronic book on the touch screen; detecting a touch in a first corner region of the page of the electronic book; changing the first corner region into a second corner region in response to the touch; detecting a continuous motion of the touch in the second corner region; and turning the displayed page in response to the continuous motion of the touch.

In accordance with an aspect of another exemplary embodiment, there is provided an apparatus including: a touch screen displaying a page of an electronic page; and a controller controlling the touch screen, wherein the controller opens a corner region of the page in response to a touch detected in the corner region of the page, detects continuous motion of the touch in the open corner region, and performs a control operation such that the page is convexly transformed and the transformed page is turned in response to the detected continuous motion of the touch.

### BRIEF DESCRIPTION OF THE DRAWINGS

The above and/or other aspects will be more apparent from the following detailed description in conjunction with the accompanying drawings, in which:

FIG. 1 is a block diagram illustrating a configuration of a portable terminal according to an exemplary embodiment;

FIGS. 2A and 2B are diagrams illustrating a page mesh according to an exemplary embodiment;

FIG. 3 is a flowchart illustrating a method of turning pages according to an exemplary embodiment;

FIG. 4 is a flowchart illustrating a procedure of turning a plurality of pages in detail;

FIG. 5 is a flowchart illustrating a method of setting an electronic book according to an exemplary embodiment;

FIG. 6 is an exemplary diagram illustrating an electronic book setting screen;

FIGS. 7A and 7B are exemplary screen diagrams for illustrating a volume of an electronic book according to an exemplary embodiment;

FIGS. 8A and 8B are exemplary screen diagrams illustrating opening of a volume region according to an exemplary embodiment;

FIGS. 9A, 9B, 9C, 9D, 10A, 10B, 10C, 10D, 11A, 11B, 11C and 11D are exemplary screen diagrams illustrating in detail the simultaneous turning of a plurality of pages according to an exemplary embodiment;

FIGS. 12A, 12B, 12C, 13A, 13B, 13C, 14A, 14B and 14C are exemplary screen diagrams illustrating in detail the automatic momentary turning of pages according to an exemplary embodiment;

FIGS. 15A, 15B and 15C are exemplary screen diagrams illustrating in detail the simultaneous turning of a plurality of pages according to another exemplary embodiment;

FIGS. 16A, 16B and 16C are exemplary screen diagrams illustrating in detail the automatic momentary turning of pages according to another exemplary embodiment;

FIGS. 17A, 17B, 17C and 17D are exemplary screen diagrams illustrating in detail the simultaneous turning of a plurality of pages according to still another exemplary embodiment;

FIGS. 18A, 18B, 18C and 18D are exemplary screen diagrams illustrating in detail a method of turning pages according to another exemplary embodiment; and

FIGS. 19A and 19B are exemplary screen diagrams illustrating in detail a method of turning pages according to still another exemplary embodiment.

### DETAILED DESCRIPTION OF EXEMPLARY EMBODIMENTS

Exemplary embodiments are described below with reference to the accompanying drawings in detail. The same reference numbers are used throughout the drawings to refer to the same or like parts.

As used herein, according to exemplary embodiments, the term “bookmark” is defined as a space capable of storing reading items (items to be read, e.g., text). The bookmark may be displayed in various forms, for example, as a folder or a bookshelf shape. The reading items stored in the bookmark may be represented in various ways, for example, may be represented as an image associated with the bindings of a plurality of electronic books, reading schedule information of an electronic book (e-book) to which a reading schedule is set, and accessories for decorating the bookmark.

According to exemplary embodiments, the ‘e-book’ may be classified by fields. The fields may chiefly include a book, a textbook, a magazine, a newspaper, a comic, and a specialty publication. The fields may be classified in detail. For example, books may be further classified into a novel, an essay, and a poem. The e-book may include a text, an image, audio, video, and user input information. The user input information may be defined as information which the user inputs separately, or as a displayed page. For instance, the user input information may be a memo, a highlighted item, images and bookmarks. The user input information may include handwriting using a touch input device (e.g., finger of a user or a stylus pen, etc.).

As used herein, according to exemplary embodiments, the term “animation” refers to a motion of contents, particularly, to the motion of a page, or a function of a terminal performing the motion. In particular, the animation may include a turning shape of pages in response to input information of the user (e.g., touch, etc.) or a three-dimensionally convexly transformed shape of the page when the user turns the page.

According to exemplary embodiments, the term ‘page mesh’ is defined as geometrical information of a page. The page mesh includes a plurality of nodes and links connecting the nodes to each other. A suitable weight value is allocated to each of the nodes and a suitable elastic value is allocated to each of the links. The elastic value may be allocated differently according to properties of paper, to achieve a feeling of turning a physical page for the user. For instance, when the page is set thickly (that is, when the weight value is large), a larger elastic value may be allocated. Conversely, when the page is relatively thin, a smaller elastic value may be allocated. A large weight value may be allocated to nodes located in an inner direction (e.g., spine). Since a location change in nodes located in a relatively outer direction (e.g., book edges) is larger than nodes located in a relatively inner direction, a small weight value may be allocated to the nodes located in a relatively outer direction. The same weight value may be allocated to all the nodes.

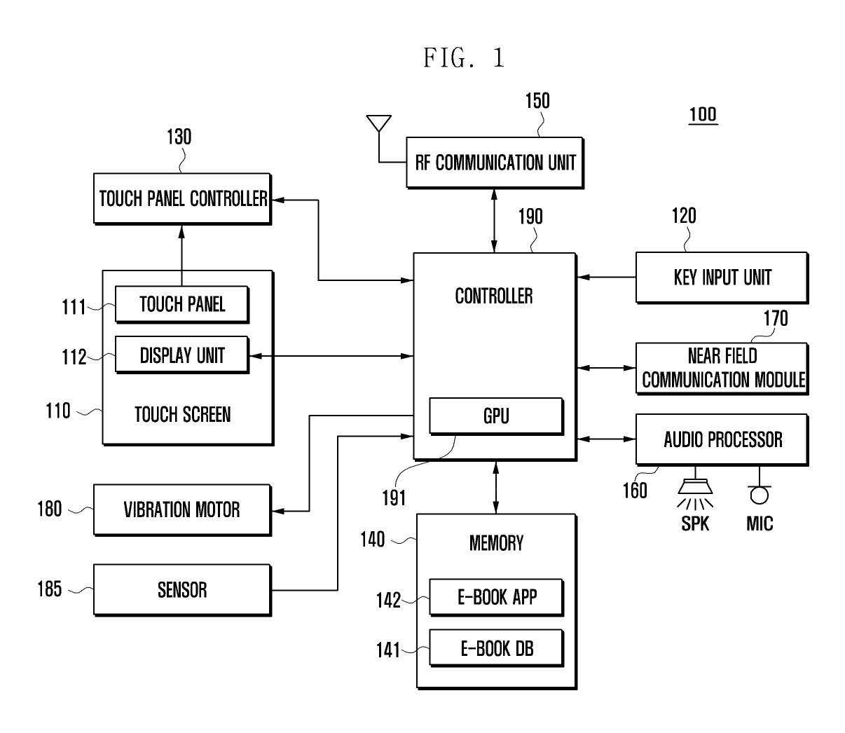

Virtual forces applied to each node may be two types. First, there is virtual internal power such as an elastic force. Second, there is virtual external power such as virtual gravity or virtual human power. The virtual gravity is defined by power attracting the node in a downward direction. If a display screen on which a page is displayed is disposed in an XY plane, and a viewpoint of the user is oriented in a positive direction of a Z axis in the XY plane, a lower portion of the XY plane may be a negative direction of the Z axis. The Z axis is perpendicular to the XY plane. The Z axis is not an actual axis, but instead is a virtual axis for three-dimensionally expressing a virtual page. The virtual gravity may be equally applied to all the nodes. However, the virtual gravity may be applied differently according to properties of paper, to achieve a lifelike feeling for the user. For example, when the user lifts and turns a page of an actual paper book, the gravity is slowly reduced when a corresponding virtual page corresponds to thin paper material and is rapidly reduced when the corresponding virtual page corresponds to a relatively thick paper material. A following table illustrates thicknesses by types of virtual pages. Referring to FIG. 1, a pamphlet may be relatively and rapidly reduced as compared with an insert.

TABLE 1

| | | |
|---|---|---|
| Insert inserted in newspaper | 52.3 | g/m² |
| Body of magazine, advertisement paper | 64 | g/m² |
| Ticket, weekly magazine cover, | 127.9 | g/m² |
| pamphlet | | |
| Fashion magazine cover, name card | 157 | g/m² |
| Sketchbook | 200 | g/m² |
| Printing paper | 75 | g/m² |

According to exemplary embodiments, virtual human power corresponds to power which the user applies to the virtual page. The virtual human power may be determined, for example, based on a user gesture (e.g., user touch motion) with respect to a touch screen. The user gesture may include a vector value including components such as a size (speed, moving distance) and a direction, such as a flick, drag, or press. A node to which virtual human power is applied by the user gesture moves in a direction corresponding to the touch motion. In this case, the virtual human power may be transferred to other nodes through links.

As a result, a sum of the internal power and the external power is applied to respective nodes in the page mesh. If the virtual human power is applied to a displayed page, a controller of a terminal (e.g., mobile smart phone) calculates virtual powers applied to respective nodes of a page mesh based on applied user gesture (e.g., human touch movement speed and direction), and transforms the page mesh based on virtual powers of the respective calculated nodes. A moving distance of a target node is multiplied by speed to obtain acceleration, and a weight of a corresponding target node is multiplied by the acceleration to obtain power. The calculation of the power is known in the art, and thus a detailed description is omitted. After that, the terminal reflects the transformed page mesh to a page to generate an animation. A procedure of generating the animation based on the human power may be executed in an Application Processor (AP), a Central Processing Unit (CPU), or a Graphics Processing Unit (GPU).

The method and apparatus for turning pages according to the exemplary embodiments are applicable to electronic devices of various types, including electronic devices which include an electronic book reader function. In particular, the method and apparatus for turning pages according to exemplary embodiments are applicable to a portable terminal including a touch screen as an input unit. The portable terminal may be implemented as various types, for example, a portable phone, a smart phone, a tablet PC, a hand-held PC, a Portable Multimedia Player (PMP), an e-book reader, and a Personal Digital Assistant (PDA). For convenience of description, the following description will be made on the assumption that the method and apparatus for turning pages according to exemplary embodiments are applied to a portable terminal having a touch screen.

The method and apparatus for turning pages according to exemplary embodiments will now be described in detail. Detailed descriptions of well-known functions and structures incorporated herein may be omitted to avoid obscuring the subject matter of the exemplary embodiments.

FIG. 1 is a block diagram illustrating a configuration of a portable terminal according to an exemplary embodiment.

Referring to FIG. 1, a portable terminal 100 according to an exemplary embodiment includes a touch screen having a touch panel 111 and a display unit 112, a key input unit 120, a touch panel controller 130, a memory 140, a radio frequency (RF) communication unit 150, an audio processor 160, a speaker SPK, a microphone MIC, a near field communication module 170, a vibration motor 180, a sensor 185, and a controller 190.

The touch panel 111 may be placed on the display unit 112, and generates and transfers a signal (e.g., touch event) to the controller 190 in response to a user gesture inputted to the touch panel 111. The touch panel 111 may be implemented by an add-on type placed on the display unit 112, an on-cell type inserted in the display unit 112, or an in-cell type. The controller 190 may detect a user gesture from a touch event inputted from the touch screen 100 and control the constituent elements.

The user gesture may be classified into a touch and a touch gesture. Here, the touch gesture may include tap, double tap, long tap, drag, drag & drop, and flick. Here, the touch is an operation where a user pushes one point of a screen using a touch input unit (device) (e.g., finger or stylus pen). The tap is an operation where the user touches the touch input unit at a corresponding point without making a motion of the touch input unit on the touch panel 111 after touching the point. The double tap is an operation where a user continuously taps twice. The long tap is an operation where the touch input unit is released from a corresponding point without making a motion of the touch input unit on the touch panel 111, after touching the point longer than the point is touched during the tap. The drag is an operation that moves the touch input unit in a predetermined direction in a state in which the touch input unit is touching the point. The drag & drop is an operation that releases the touch of a touch input unit after a drag. The flick is an operation that releases a touch input unit after bouncing the touch input unit at high speed, e.g., flipping motion. The touch refers to a state in which the touch screen is contacted, and the touch gesture refers to a motion from touch-on of the touch on the touch screen to touch-off of the touch.

Further, a resistive type, a capacitive type, and a pressure type are applicable to the touch panel 111.

The display unit 112 converts image data inputted from the controller 190 into an analog signal, and displays the analog signal under the control of the controller 190. That is, the display unit 112 may provide various screens according to use of the portable terminal, for example, a lock screen, a home screen, an application (hereinafter referred to as ‘App’) execution screen, a menu screen, a keypad screen, a message creation screen, and an Internet screen. A lock screen may be defined as an image displayed when a screen of the display unit 112 becomes large. When a specific touch event for releasing the locking occurs, the controller 190 may convert a displayed image from a lock screen into a home screen or an App execution screen. The home screen may be defined as an image including a plurality of App icons corresponding to a plurality of Apps, respectively. When one is selected from a plurality of App icons by a user, the controller 190 may execute a corresponding App, for example, electronic book App, and display a corresponding execution screen.

The display unit 112 may display animation images under the control of the controller 190. In an embodiment, the display unit 112 may display an animation in which pages are turned and an animation in which pages are pressed. The animation in which pages are turned may be changed according to a thickness of a page, a touch point in the page, a moving distance of the touch, a motion direction of the touch, or speed of the touch. The animation in which pages are pressed may be changed according to a location of a pressed point, an intensity of the pressing, and the number of pages remaining below the pressed page.

The display unit 112 may be configured in the form of a flat panel display such as a Liquid Crystal Display (LCD), an Organic Light Emitted Diode (OLED), and an Active Matrix Organic Light Emitted Diode (AMOLED).

The key input unit 120 may include a plurality of input keys and function keys for receiving numeric or character information and setting various functions. The function keys may include arrow keys, side keys, and hot keys set such that a specific function is performed. The key input unit 120 generates and transfers a key signal associated with a user setting and function control of the portable terminal 100 to the controller 190. The key signal may be classified as an on/off signal, a volume control signal, and a screen on/off signal. The controller 190 controls the foregoing constituent elements in response to the key signal. The key input unit 120 may include a QWERTY keypad, a 3*4 keypad, and a 4*3 keypad having a plurality of keys. When the touch panel 111 of the portable terminal is supported in the form of a full touch screen, the key input unit 120 may include only one side key which turns the screen on/off and turns the portable terminal on/off, and which is provided in a side of a case of the portable terminal 100.

The touch panel controller 130 is connected to the touch panel 111, receives a touch event from the touch panel 111, and Analog to Digital (AD)-converts and transfers the received touch event to the controller 190. The controller 190 detects a touch gesture from the transferred touch event. That is, the controller 190 may detect a touch point, a moving distance of touch, a motion direction of the touch, speed of the touch, and pressure of the touch.

The memory 140 may store an Operating System (OS) of the portable terminal, an App and various data necessary for the operation of the apparatuses according to exemplary embodiments. The memory 140 may chiefly include a data region and a program area. The data area of the memory 140 may store data, namely, an e-book, a contact point, an image, a document, video, messages, mail, music, a sound effect generated from the portable terminal 100 or downloaded from the outside according to use of the portable terminal 100. The data area may store the screen which the display unit 112 displays. The menu screen may include a screen switch key (e.g., a return key for returning to a previous screen) for switching the screen and a control key for controlling a currently executed App. The data area may store data which the user copies from messages, photographs, web pages, or documents for copy & paste. The data area may store various preset values (e.g., screen brightness, presence of vibration during generation of touch, presence of automatic rotation of the screen) for operating the portable terminal 100. The data area may store an e-book DB 141 including a plurality of e-books. The data area may store reading situation information with respect to a plurality of stored e-books. The reading situation information may include stored date of an e-book, the read number of an e-book, a read page, a read date, a non-read page, and user input information. The user input information may be displayed simultaneously with displaying a corresponding page.

The program area of the memory 140 may store an Operating System (OS) and various Apps for booting the portable terminal and operating the foregoing constituent elements. In detail, the program area may store a web browser for accessing the Internet, an MP3 player for playing a sound source, and a camera App for photographing, displaying, and storing a subject. The program area may store an e-book App 142 for executing e-books stored in the e-book DB 141.

The RF communication unit 150 performs voice calls, image calls, or data communication under the control of the controller 190. To do this, the RF communication unit 150 may include an RF transmitter for up-converting a frequency of a transmitted signal and amplifying the converted signal, and an RF receiver for low-noise-amplifying a frequency of a received signal and down-converting the amplified signal. The RF communication unit 150 may include a mobile communication module (e.g., 3-generation mobile communication module, 3.5-generation mobile communication module, or 4-generation mobile communication module, etc.), and a digital broadcasting module (e.g., DMB module).

The audio processor 160 performs a function of transmitting an audio signal inputted from the controller 190 to the speaker SPK and transfers an audio signal such as a user's voice inputted from the microphone MIC to the controller 190. That is, the audio processor 160 converts voice/sound data into an audible sound and outputs the audible sound through the speaker SPK under control of the controller 190. The audio processor 160 may convert an audio signal such as a user's voice received from the microphone MIC into a digital signal and transfer the digital signal to the controller 190. Particularly, the audio processor 160 according to exemplary embodiments outputs a sound effect resembling the sound of pages being turned to the speaker SPK under control of the controller 190. The sound effect resembling the sound of pages being turned may be changed according to a thickness of the page, a touch point in the page, a moving distance of a touch, a motion direction of the touch, or speed of the touch. The audio processor 160 may output the sound effect resembling the sound of pages being turned to the speaker SPK. Also, a sound effect resembling the sound of pages being pressed may be changed according to a location a press point, intensity of the press, a duration time of the press, and the number of pages remaining below the pressed page.

The near field communication module 170 performs a function of connecting the portable terminal 100 to an external device in a wired or wireless scheme. The near distance communication module 170 may include a Zigbee module, a Wi-Fi module, or a Bluetooth module. In particular, according to exemplary embodiments, the near field communication module 170 may receive an e-book from the external device and transfer the received e-book to the memory 140.

The vibration motor 180 performs vibration under the control of the controller 190. Particularly, the vibration motor 180 provides feedback using haptic technology. That is, the controller 190 controls the vibration motor 180 to provide feedback simulating a feeling in which pages are turned by driving one or more vibration motors according to a motion of the touch gesture. The feedback by the vibration motor 180 may be changed according to materials or a thickness of the page.

The sensor 185 may detect at least one of various types of variations such as slope variation, luminance variation, or acceleration variation, and transfer a corresponding electric signal to the controller 190. The sensor 185 may detect state variation achieved based on the portable terminal 100, and generate and transfer a corresponding detection signal to the controller 190. The sensor 185 may be configured by various sensors. During driving of the portable terminal 100 (or based on a user setting), power is supplied to at least one sensor set according to the control of the controller 190, so that state variation of the portable terminal 100 may be detected. According to an exemplary embodiment, the sensor 185 may operate to detect state variation of the portable terminal 100, particularly, gradient variation. In the exemplary embodiment, the sensor 185 may be driven according to a user setting or a manual operation of the user.

The sensor 185 may include at least one of various forms of sensing devices capable of detecting state variation of the portable terminal 100. For instance, the sensor 185 may include at least one of various sensing devices such as an acceleration Sensor, a gyro Sensor, a luminance sensor, a proximity sensor, a pressure sensor, a noise sensor (e.g., microphone), a video sensor (e.g., camera module), and a timer. The sensor 185 may be implemented by integrating a plurality of sensors (e.g., sensor 1, sensor 2, sensor 3, etc.) with one chip or a plurality of sensors may be implemented as separate chips. For example, the controller 190 may determine a current state according to gradient information (e.g., measured values with respect to an x axis, y axis, and z axis) detected by an operation sensor.

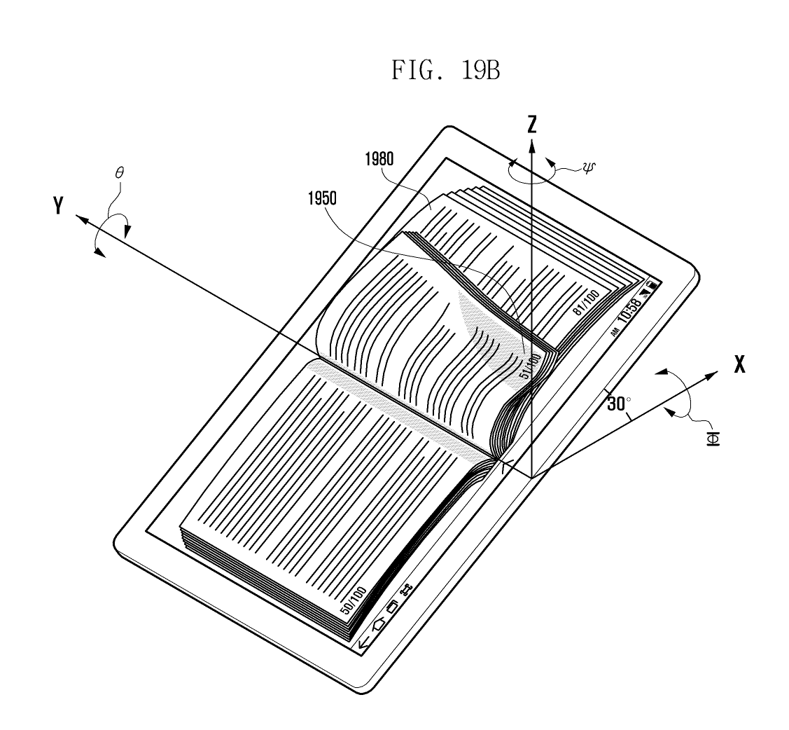

The sensor 185 may measure acceleration of the portable terminal 100 to generate an electric signal, and transfer the generated electric signal to the controller 190. For example, assuming that the sensor 185 is a 3 axis acceleration sensor, the sensor 185 may measure gravity accelerations with respect to the X axis, Y axis, and Z axis, as shown in FIGS. 19A and 19B. Particularly, the sensor 185 measures acceleration when a motion acceleration and a gravity acceleration of the portable terminal 100 are added. However, when the portable terminal 100 does not move, the sensor 185 may measure only the gravity acceleration. For example, the following description will be made on the assumption that a front surface of the portable terminal 100 orienting upwards is a positive (+) direction of the gravity acceleration and a rear surface of the portable terminal 100 orienting upwards is a negative (−) direction of the gravity acceleration. As shown in FIGS. 19A and 19B, when a rear surface portion of the portable terminal 100 makes contact with and is put on a horizontal surface, X axis and Y axis components of gravity acceleration measured by the sensor 185 are 0 m/sec2 and only a Z axis component is a specific positive amount (e.g., +9.8 m/sec2). In contrast, when a front surface portion of the portable terminal 100 makes contact with and is put on a horizontal surface, X axis and Y axis components of gravity acceleration measured by the sensor 185 are 0 m/sec2 and only a Z axis component is a specific negative amount (e.g., −9.8 m/sec2).

When a user lifts the portable terminal 100 so that the portable terminal is put obliquely, at least one axis in the gravity acceleration measured by the sensor 185 is not 0 m/sec2, and a square root of a sum of a square of three axis components, namely, a vector sum, may become a specific value (e.g., 9.8 m/sec2). The sensor 185 detects accelerations with respect to the X axis, Y axis, and Z axis directions, respectively. According to a coupling location of the sensor 185, respective axes and corresponding gravity accelerations may be changed.

The controller 190 performs a function of controlling an overall operation of the portable terminal 100 and signal flow between internal constituent elements of the portable terminal 100, and also processes data. The controller 190 controls a power supply supplied from a battery to internal constituent elements. The controller 190 executes various applications stored in the program area. The controller 190 executes an animation whose page is turned in response to a touch gesture (e.g., drag or flick). The controller 190 transforms a page in response to a touch gesture and gradient information of the portable terminal. To do this, the controller 190 may include a GPU 191.

The GPU 191 may perform a function of changing a page mesh in response to a touch gesture and reflects the transformed page mesh to generate an animation. In detail, the GPU 191 receives information associated with a touch gesture from the touch panel controller 130. The GPU 191 transforms the page mesh based on the received information. If a user gesture (e.g., touch input) is applied to a page, the GPU 191 transforms a page mesh in response to the user gesture. When the user gesture disappears from the page, for example, when the user drags and releases touching of the page or presses the page and then releases the page, the GPU 191 restores the page mesh to an original state. That is, the transformed page mesh is restored to an original state based on elastic characteristics of links and a gravity applied to respective nodes. The GPU 191 receives pages from the memory 140. The GPU 191 reflects transformation information of the page mesh to a page received from the memory 140 to generate an animation. The transformation information of the page mesh includes coordinate values (x, y, z) of respective nodes configuring the page mesh. The GPU 191 controls the display unit 112 to display the animation.

When the gravity acceleration transferred from the sensor 185 is measured for at least one axis component, the controller 190 may calculate a gradient of the portable terminal 100 using accelerations with respect to respective axes. Here, the calculated gradient may include a roll angle φ, a pitch angle θ, and a yaw angle ψ. The roll angle φ indicates a rotating angle based on an X axis in FIGS. 19A and 19B, the pitch angle θ indicates a rotating angle based on a Y axis in FIGS. 19A and 19B, and a yaw angle ψ indicates a rotating angle based on a Z axis in FIGS. 19A and 19B. In the exemplary case shown in FIGS. 19A and 19B, X axis and Y axis gravity accelerations in a gravity acceleration transferred from the sensor 185 are 0 m/sec2 and a Z axis gravity acceleration is +9.8 m/sec2, and a gradient (φ, θ, ψ) of the portable terminal 100 may be (0, 0, 0). A certain gradient of the portable terminal 100 may be computed by the foregoing scheme. The controller 190 may compute the gradient of the portable terminal 100 through an algorithm such as a pose calculation algorithm using Euler angles, a pose calculation algorithm using an extended Kalman filter, or an acceleration estimation switching algorithm. That is, according to exemplary embodiments, a method of measuring a gradient of the portable terminal 100 using an accelerometer may be implemented using various schemes.

The GPU 191 may perform a function of transforming a page mesh in response to gradient variation of the portable terminal 100, and reflecting the transformed page mesh to a page to generate an animation. The GPU 191 receives gradient information of the portable terminal 100 from the controller 190. The GPU 191 computes a transformed degree of a page based on the received information, and generates and displays an animation corresponding to the computation result. For example, when a gradient (φ, θ, ψ) of the portable terminal 100 is (0, 0, 60), a display mode is a transverse mode displaying two pages in left and right sides of the screen, and a residual amount of the pages on a right side of the screen is 200 pages, the GPU 191 may generate and display an animation in which 100 pages are turned to a left side. A page turning mode may include a normal mode, a gradient mode, and a merge mode. The page turning mode may be set by the user. When the user selects a normal mode, the GPU 191 generates an animation in response to the detected touch gesture. When the user selects the gradient mode, the GPU 191 generates the animation using only computed gradient information. When the user selects the merge mode, the GPU 191 generates in consideration of both of the touch gesture and the gradient information. Attribute information (e.g., thickness, weight, material, etc.) set in a page in respective modes may be considered in transforming the page. Alternatively, the attribute information may not be considered in transforming the page. The animation may be generated by the GPU 191 or an application processor (AP). Alternatively, the animation may be generated by both of the GPU 191 and the AP. The AP may be configured by as a CPU and a GPU as a system on chip (SoC). The AP may be configured by packaging the CPU and the GPU in a multi-layer format.

Since the constituent elements may change according to trends of digital device technology, e.g., convergence trends, the constituent elements described above are exemplary only and are not limited to any specific devices. The portable terminal 100 according to exemplary embodiments may further include constituent elements which are not mentioned above, such as a GPS module and a camera module. The portable terminal 100 according to exemplary embodiments may be implemented in accordance with specific constructions according to preferences.

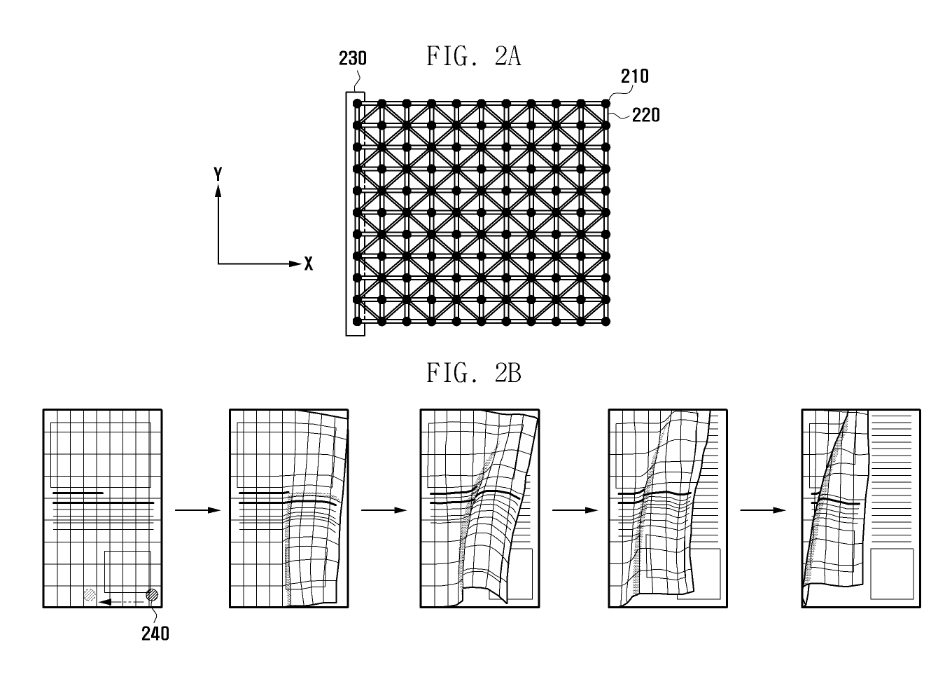

FIGS. 2A and 2B are diagrams illustrating a page mesh according to an exemplary embodiment.

Referring to FIG. 2A, the controller 190, particularly, the GPU 191 configures a page mesh. The page mesh includes a plurality of nodes and a plurality of links connecting the nodes to each other. In the drawings, reference numeral 210 represents a plurality of nodes, and reference numeral 220 represents a plurality of links. As shown, the nodes may be arranged in a matrix pattern, and locations thereof may be indicated by XY coordinates. As described above, a suitable weight value is allocated to respective nodes and a suitable elastic value is allocated to respective links (springs). A great weight value may be allocated to nodes located in the center 230 of an e-book. A weight value less than the weight value of the center 230 may be allocated to nodes located in an outer side relatively away from the center 230. As a result, the motion of a node located in an outer side is a relatively lightweight motion. The node located in the outer side reacts sensitively to a touch gesture of the user. As the page is turned, nodes located in a central axis (X axis) 230 are fixed unlike other nodes, and the same weight value may be allocated to all the nodes located in the central axis. The motion of the page mesh may be collectively heavy as compared with a previous case. That is, a transformed degree of the page may be changed according to attribute information (e.g., thickness, weight, material, etc.) set in a corresponding page. The transformed degree of the page may be changed according to the computed gradient.

When a user input, such as a touch gesture, is applied to the displayed page, the controller 190, particularly, the GPU 191, detects the touch gesture, transforms a page mesh in response to the detected touch gesture, and reflects the transformed page mesh to the page to generate an animation of the page being turned. In detail, referring to FIG. 2B, the user touches a right bottom point 240 of a page using a predetermined touch input unit (e.g., finger, pen, etc.). Then, the GPU 191 detects a node which the touch input unit touches. After that, the user moves the touch input unit from a right bottom point 240 in a leftward direction. Then, the GPU 191 moves a touched node (hereinafter also referred to as ‘target node’ for convenience of description) in a leftward direction on an XY plane according to the motion of the touch input unit. That is, the target node moves in a direction perpendicular to a direction of gravity. The GPU 191 calculates displacement of a moved target node. The displacement is a vector value having a size and a direction. The size of the displacement includes at least one of a current location of the target node, a moving distance of the target node, and speed of the target node. For example, the size of the displacement may include only a current location of the target node, only a moving distance of the target node, or a combination of the moving distance of the target node and the speed of the target node. The controller 190 may transform a page mesh according to the computed displacement and reflect the transformed page to a page to generate an animation.

The GPU 191 calculates powers applied to respective nodes using the calculated displacement. The power is a vector value having a size and a direction. In an embodiment, the power is a sum of elastic power, gravity, and virtual human power associated with a user gesture (e.g., speed and/or moving distance of touch input). When the page turning mode is set to a gradient mode or a merge mode, the power may further include a gradient of the portable terminal. The GPU 191 calculates locations of the nodes using the calculated powers. The GPU 191 generates an animation, for example, as illustrated in FIG. 2B using the calculated locations. Meanwhile, the GPU 191 may move the target node (namely, a node to which the human power is directly applied) in a direction perpendicular to gravity. That is, as an X axis value and a Y axis value of the target node are changed, a Z axis value is changed or remains at ‘0’.

The GPU 191 fixes a node located in a central axis 230, unlike other nodes. This configuration therefore closely resembles the situation in which the user actually pushes and moves a page of a paper book. Accordingly, as shown in FIG. 2B, the transformed page is expressed in a convex form. As described above and as illustrated with reference to FIGS. 2A and 2B, the page mesh may be transformed in various ways according to a touch point, a motion direction of a touch, and speed of the touch. Accordingly, the user may experience a feeling which is similar to the feeling of turning pages in a paper book through an e-book according to the exemplary embodiments.

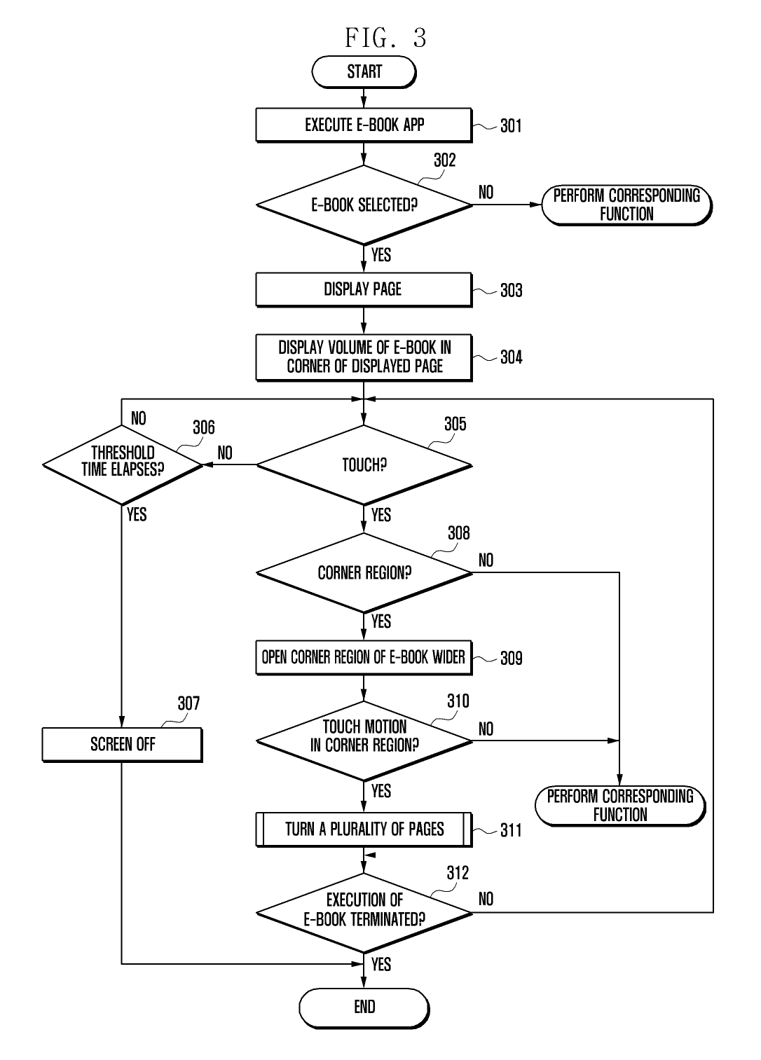

FIG. 3 is a flowchart illustrating a method of turning pages according to an exemplary embodiment.

Referring to FIG. 3, the controller 190 may first be in an idle state. For example, the controller 190 displays a home screen including an icon for executing an e-book App. The controller 190 may detect a user gesture associated with an execution request of the electronic book App. At operation 301, when the execution request of the e-book App is detected, the controller 190 may execute the e-book App and control the portable terminal 100 such that a bookmark screen is displayed. At operation 302, the controller 190 may detect a user gesture selecting an icon of one of a plurality of e-books. Step 302 may alternatively be omitted. That is, when the e-book App is executed, a page of the e-book may be displayed. At operation 303, the controller 190 controls the portable terminal 100 in such a manner that a page of the selected e-book is read from a database and is displayed. When the e-book is initially opened, a list or a first page of e-book may be displayed. When the e-book is previously viewed, a finally stored page may be displayed. When a user gesture associated with an execution request of a function other than selection of the e-book, for example, a bookmark edit function, is detected at step 302, a corresponding function is performed. At operation 304, the controller 190 displays a volume of an e-book in a corner of the displayed page. That is, the controller 190 displays a volume (i.e., a representation of a quantity) of an e-book proportional to the number of remaining pages based on the page number of a current displayed page. For example, when the total number of e-book pages is 100 and the page number of a currently displayed page is 21, the number of remaining pages is 80. Accordingly, the display unit 190 displays a volume corresponding to 80 pages on the corner of a screen. When the number of remaining pages 20, the display unit 112 displays a volume corresponding to 20 pages on the corner of the screen. Also, the controller 190 may change a displayed volume each time a preset number of pages is turned. For instance, when the preset number is 10 pages, the displayed volume may be the same when the displayed pages are in the range of 1 to 10. However, when a page number of the displayed page is 11 (e.g., when the user turns to page 11), although there is only a difference of one page as compared with a case where a page number is ‘10’, a volume of a corner may be displayed differently (e.g., to be thin) based on the preset number of pages being exceeded. The preset number of pages may be changed by the user. Also, the controller 190 may display a volume of an e-book proportional to a thickness of the type of page. For example, referring to table 1, although the number of pages is the same, the volume of a sketchbook is larger than the volume of the printing paper.

As described above, while displaying pages of an e-book together with volume information of the e-book, at operation 305, the controller 190 determines whether a touch is detected. When the touch is not detected, the process proceeds to operation 306. At operation 306, the controller 190 determines whether a threshold time elapses. The threshold time is defined as a value set to automatically turn-off a screen. At operation 307, when no touch is detected by the time that the threshold time elapses, the controller 190 turns off a screen. The threshold time may be set to many different values (e.g., 30 seconds, 1 minute, etc.) and be changed by the user. Alternatively, the process may be terminated without performing operation 307.

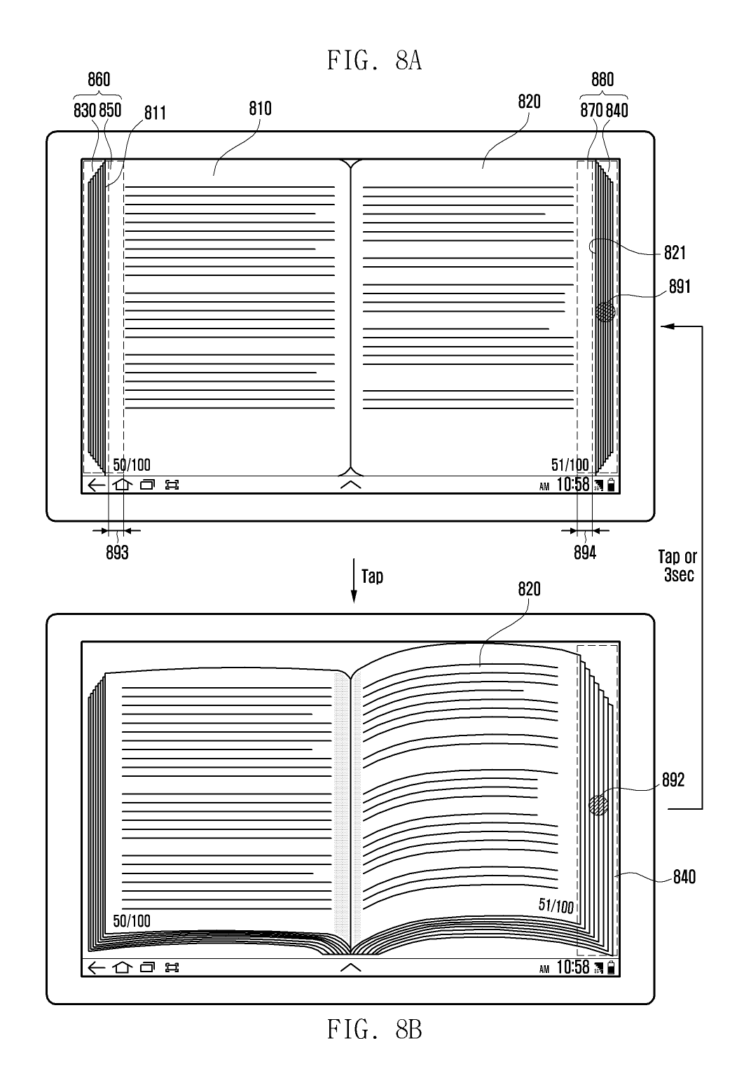

At operation 308, when the touch is detected, the controller 190 determines whether the detected touch is a user gesture (e.g., tap) for selecting a corner region. The corner region includes a volume region on which a volume of the e-book is displayed. The corner region may further include an additional region from a corner of the page to a transverse length (e.g., 1 cm) set in an inner side of the page (a detailed description of the additional region will be described with reference to FIGS. 8A and 8B).

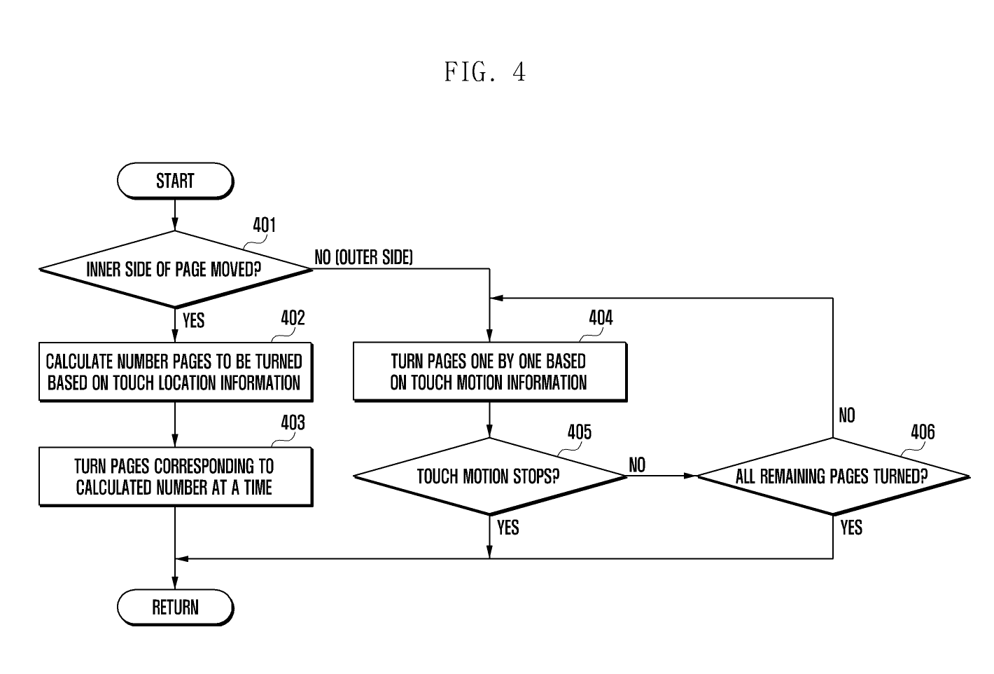

When the detected user gesture is not associated with selection of a corner region but, for example, a display request of a bookmark screen, the controller 190 performs a corresponding function. At operation 309, when the user gesture is associated with the selection of the corner region, the controller 190 opens a corner region of an e-book wider than a volume of the corner displayed at step 304. The corner region is open and the detected touch may be released. A touch to which an open corner region is added is detected and a drag and a flick may be directly detected. At operation 310, the controller 190 determines whether a touch motion such as drag or flick occurs in the open corner region. When the touch motion occurs, at operation 311, the controller 190 turns a plurality of pages. Operation 311 will be described in detail with reference to FIG. 4. After turning a plurality of pages, at operation 312, the controller 190 determines whether execution of an e-book is terminated. When the execution of the e-book is not terminated, the process returns to operation 305.

FIG. 4 is a flowchart illustrating operation 311 in detail, namely, illustrating a procedure of turning a plurality of pages according to exemplary embodiments.

Referring to FIG. 4, at operation 401, a controller 190 determines whether a touch is moving to an inner side of a page. At operation 402, when the motion direction of a touch is towards the inner side of a page, the controller 190 calculates the number pages to be turned based on touch location information. When a current display mode is a landscape mode, the controller 190 displays two pages, one page on the left side of a screen and one page on the right side of the screen. When the current display mode is a portrait mode, the controller 190 may display only one page. When the current display mode is the landscape mode and a touched corner is a right page, the inner side corresponds to moving to a left side. When the current display mode is the landscape mode and the touched corner is a left page, the inner side corresponds to moving to a right side. When the current display mode is the portrait mode, the touched corner may be located in a right side of the screen. Accordingly, when the current display mode is the portrait mode, the inner side corresponds to moving to a left side.

At operation 403, the controller 190 turns pages corresponding to the calculated number at a time (simultaneously). Steps 402 and 403 will be described in detail. The controller 190 first confirms the number of remaining pages. For instance, when the total number of pages of the e-book is 100 and a page number of a currently displayed page is 21, the number of remaining pages is 80. The controller 190 normalizes a width of a corner region based on the confirmed number of remaining pages. For example, when the number of remaining pages is 80, a width of the corner region may be normalized in the range of 1 to 80. After that, the controller 190 confirms a normalization value matching with a touched X coordinate. The controller 190 turns pages by the number corresponding to a normalization value matching with the touched X coordinate. For instance, when a normalization value matching with the touched X coordinate is 10, the controller 190 turns a total of 10 pages, from page number 21 to page number 30, to an inner side at a time. When the motion direction of the touch is in a direction opposite to the inner side, that is, when the user flips a touch input device to an outer side, at operation 404, the controller 190 sequentially turns pages one by one (or two by two) based on touch motion information. The number of simultaneously turned pages may be set by the user. The touch motion information may include one of moving speed of a touch, a moving distance of the touch, and the number of remaining pages. For instance, when the moving speed of the touch is high, the controller 190 may rapidly turn the pages. Also, when the moving distance of the touch becomes longer, the controller 190 may more rapidly turn the pages. When the number of remaining pages is reduced, the controller 190 may rapidly turn the pages. The touch motion information may, for example, include at least two of the moving speed, the moving distance, and the number of remaining pages.

At operation 405, the controller 190 determines whether the touch motion stops. When the user releases the touch or stops the motion while maintaining the touch, sequential turning of pages is terminated. Otherwise, at operation 406, the controller 190 determines whether all remaining pages are turned. If pages still remain to be turned, the process returns to operation 404. When all of the remaining pages are turned, sequential turning of the pages is terminated.

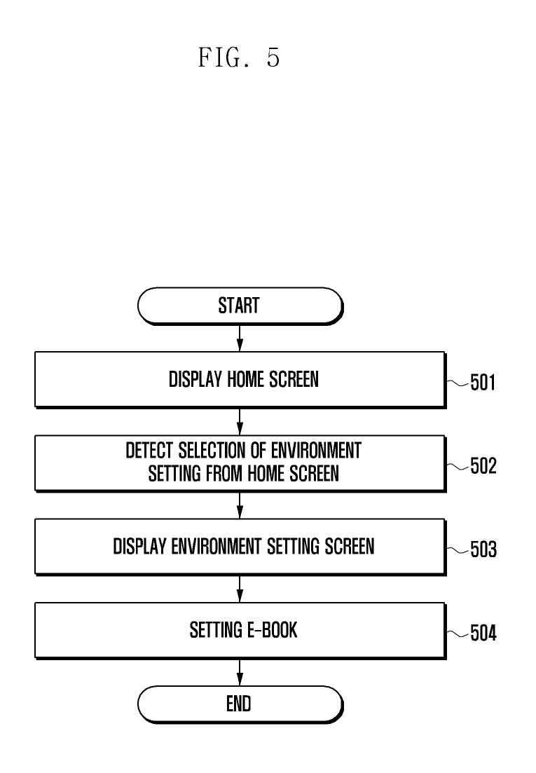

FIG. 5 is a flowchart illustrating a method of setting an electronic book according to an exemplary embodiment.

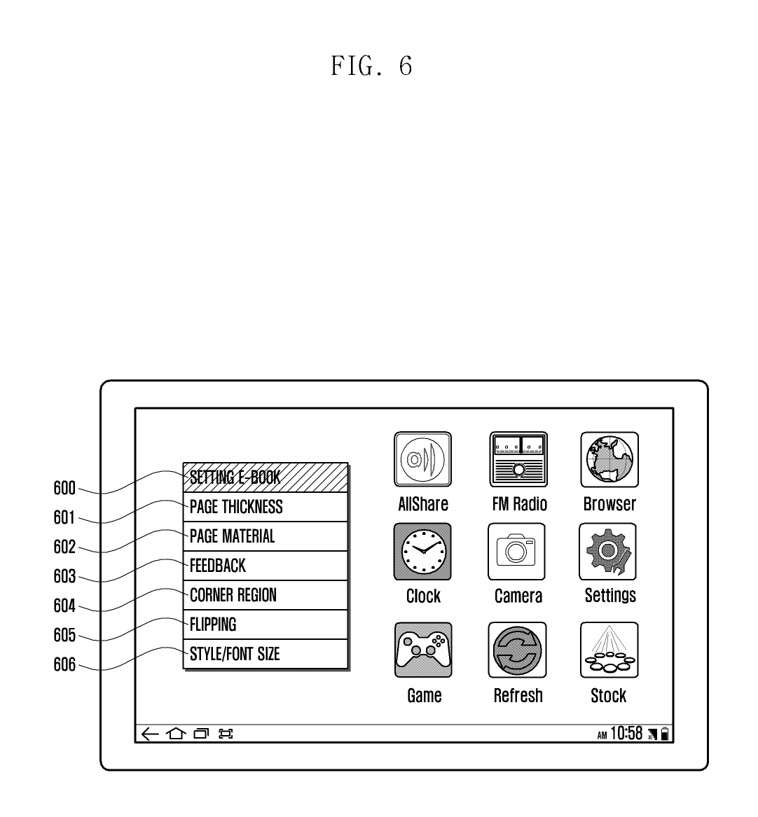

Referring to FIG. 5, at operation 501, a controller 190 may control a display unit 112 to display a home screen. The home screen includes an icon corresponding to the environment setting, which is used to set the environment settings. The user may select the icon corresponding to the environment setting. At operation 502, the controller 190 detects a selection made by a user with respect to an icon corresponding to the environment setting from the home screen. At operation 503, the controller 190 controls the display unit 112 to display an environment setting screen of the portable terminal 100. The user may operate the touch panel 111 in a state that the environment setting screen is displayed to set an environment of the e-book. The e-book setting information is stored in the memory 140 of the portable terminal 100. The e-book setting information stored in the memory 140 may be used when the e-book App 142 is executed. Items included in the environment setting screen may be various types according to the performance and functions of the portable terminal 100. For example, the environment setting screen may include items such as a wireless network connection through which the portable terminal 100 is connected, a location service, sound settings, display characteristics, security settings, and information related to e-books. The user may touch an e-book item from the foregoing items. Then, as shown in FIG. 6, the controller 190 controls the display unit to display an e-book setting screen.

FIG. 6 is an exemplary diagram illustrating an electronic book (e-book) setting screen. Referring to FIG. 6, the display unit 112 may display the e-book setting screen 600 under the control of the controller 190. As shown, the e-book setting screen 600 may include icons corresponding to a page thickness 601, a page material 602, feedback 603, a corner region 604, flipping 605, and style/font size 606. For example, the page thickness 601 and the page material 602 may be 75 g/m2 and a printing page, respectively. The page thickness 601 and the page material 602 are set by a manufacturing company of an e-book. The feedback 603 is an item for determining feedback provided to the user when the pages are turned. For instance, the user may set at least one of vibration and a sound effect as the feedback. The corner 604 is an item for determining a corner region of a page. For example, the corner region may be set to include a volume region. The corner region may be set to further include an additional region. The user may set a length to an inner side of the additional region in an item of the corner region 604. A unit of the length may vary. However, for example, the unit of the length may be set to centimeters. The length may be set as a font unit. The user may set an open degree of a volume region in the item of the corner region 604. For instance, a transverse side of the volume region may be set to be longer than twice a preset length. The user may set a page unit of the volume in the item of the corner region 604. The flipping 605 is an item for setting sequential automatic turning (namely, operation 404) of the foregoing pages. For example, the user may set the number of pages to be simultaneously turned in the item of the flipping 605. The style/font size is an item for setting a style and the size of characters displayed on a page. For example, the user may set ‘gothic’ as the style. The size of the character may be set to 12 points.

Hereinafter, exemplary embodiments will be described with reference to exemplary screen diagrams. According to exemplary embodiments, a display mode is divided into a landscape mode and a portrait mode. Accordingly, when the current display mode is the landscape mode, the portable terminal 100 displays two pages on left and right sides of the screen. When the current display mode is the portrait mode, the portable terminal 100 displays one page. However, the exemplary embodiments are not limited thereto. When the user rotates the portable terminal 100, a sensor of the portable terminal 100 detects the rotation of the portable terminal 100 and transfers detection information to the controller 170. The controller 170 may determine a display mode of the portable terminal 100 based on the transferred detection information.

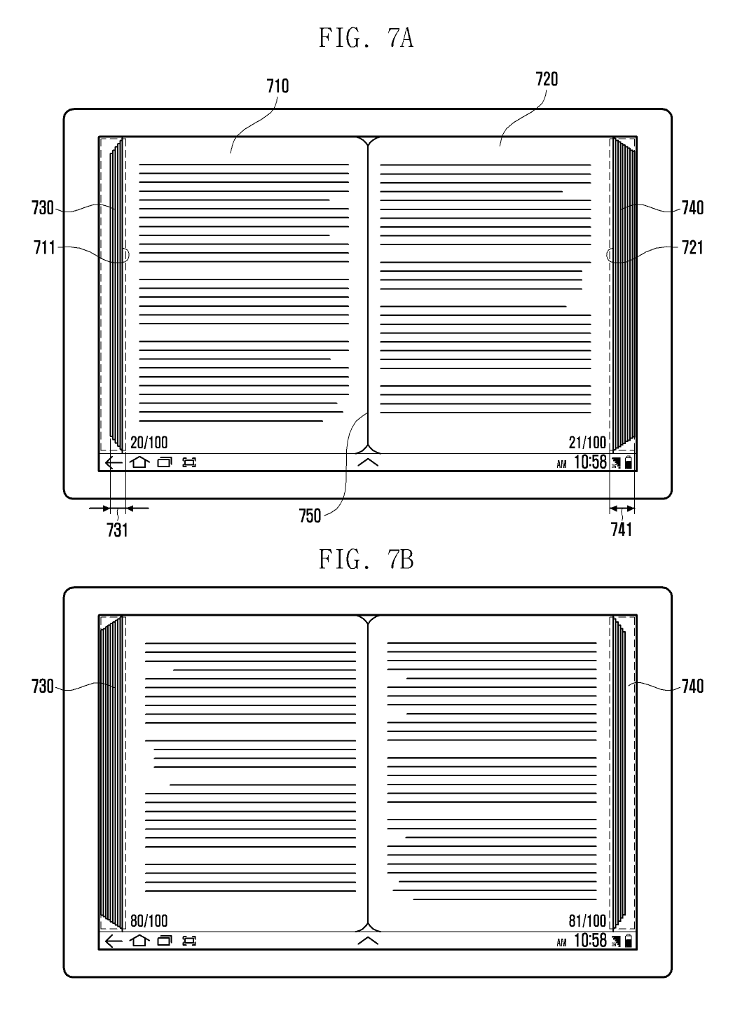

FIGS. 7A and 7B are exemplary screen diagrams for illustrating a volume of an electronic book according to an exemplary embodiment.

First, referring to FIG. 7A, a display mode is a landscape mode and the display unit 112 displays a first page 710 and a second page 720 in left and right sides of the screen. The display unit 112 displays a first volume region 730 in a left corner 711 of the first page 710. The display unit 112 displays a second volume region 740 in a right corner 721 of the second page 720. Reference numeral 750 indicates a central line for distinguishing the two pages 710 and 720 from each other.

A first transverse length 731 of the first volume region 730 and a second transverse length 741 of the second volume region 740 are proportional to the number of remaining pages. For example, when a page number of the first page 710 is page number 20 out of a total of 100 pages, and a page number of the second page 720 is page number 21 of the total of 100 pages, the number of pages corresponding to the first volume region 730 is 20 and the number of pages corresponding to the second volume region 740 is 80. Accordingly, referring to FIG. 7(a), the second volume region 740 is displayed to be thicker than the first volume region 730. The controller 190 may turn a plurality of pages (e.g., 60 pages) from a right side to a left side in response to a user gesture turning pages. For example, when 60 pages are turned, as shown in FIG. 7B, the first volume region 730 is displayed to be thicker than the second volume region 740.

FIGS. 8A and 8B are is exemplary screen diagrams illustrating opening of a volume region according to an exemplary embodiment.

First, referring to FIG. 8A, the display unit 112 displays a first page 810 and a second page 820 on left and right sides of a screen, respectively. The display unit 112 displays the first volume region 830 in a left corner 811 of the first page 810. The display unit 112 displays a second volume region 840 in a right corner 821 of the second page 820.

The first corner region 860 may include only the first volume region 830. Alternatively, the first corner region 860 may further include a first additional region 850. Here, the first additional region 850 refers to a region having a first transverse length 893, for example, 1 cm, which was previously set as an inner side (namely, right side with reference to FIG. 8A) in the left corner 811. The second corner region 880 may include a second volume region 840. The second corner region 880 may further include a second additional region 870. The second additional region 870 refers to a region having a second transverse length 894, which was previously set as an inner side (namely, left side with reference to FIG. 8A) in the right corner 821. The first transverse length 893 and the second transverse length 894 may be the same length or different lengths from each other. For example, the controller 190 detects touch frequencies of a left page and a right page. When a detection frequency of the right page is greater than that of the left page, the second transverse length 894 may be set to be longer than that of the first transverse length 893.

When the user taps (891) the second corner region 880, as shown in FIG. 8B, the controller 190 widely opens the second corner region 880, and a second volume region 840′ is displayed. For example, a transverse length of the second volume region 840′ may be greater than a transverse length of the related art 840. As shown in FIG. 8B, similar to a situation in which the user actually holds a corner of a paper book and convexly bends the paper book, a whole part of the second page 820′ may be convexly transformed. The controller 190 may convexly transform a predetermined region of the second page 820′. For instance, the predetermined region may be a lower end of the second page 820′. A lower portion of the second page 820′ is convex. A convex degree of the second page 820′ becomes smaller as the second page 820′ reaches a top end. The top end of the second page 820′ is transformed to a much smaller degree. When a preset time (e.g., 3 seconds) elapses after the user taps or opens the second volume region 840′, the second volume region 840 may be restored to an original state.

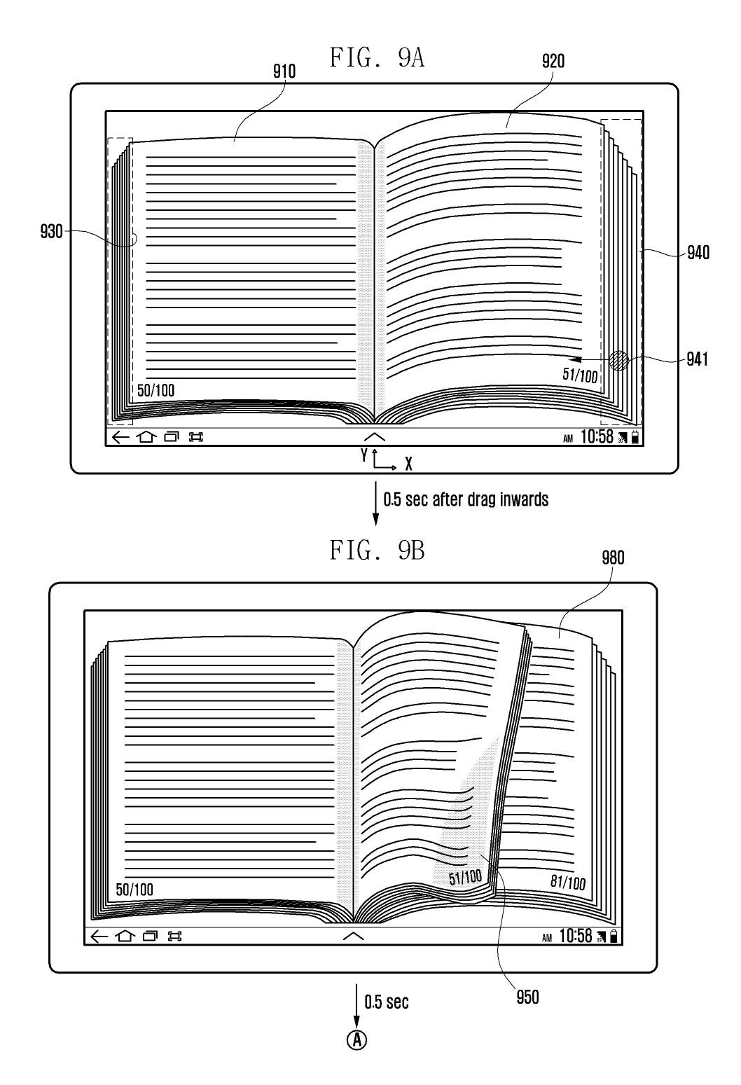

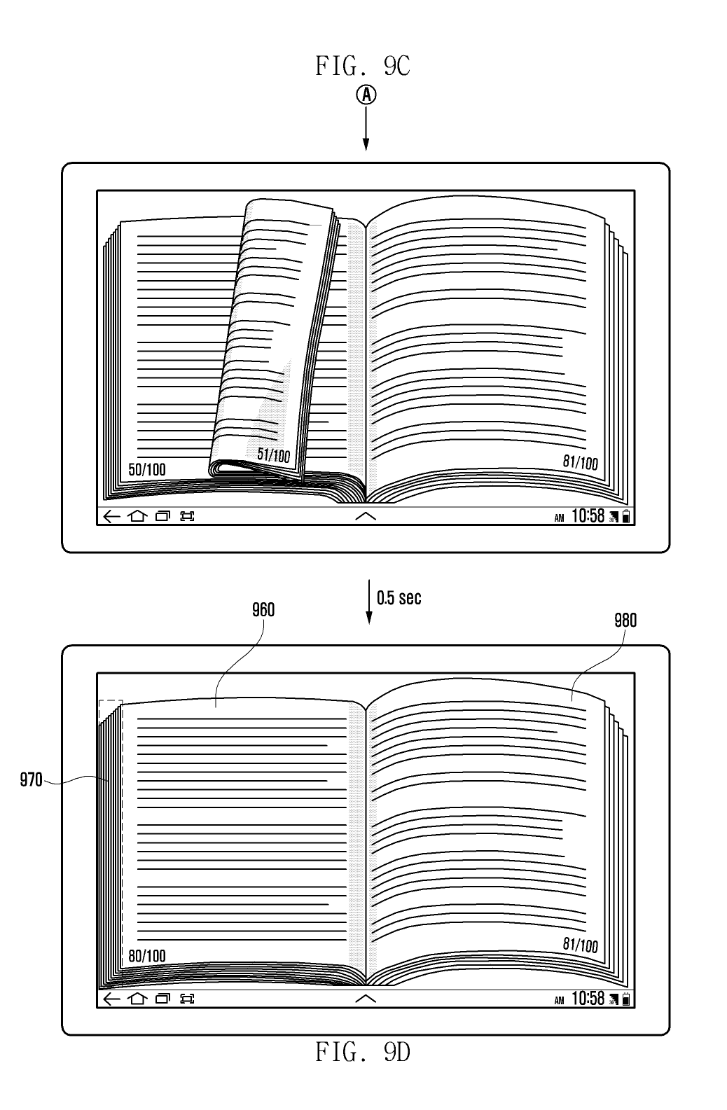

FIGS. 9A, 9B, 9C, 9D, 10A, 10B, 10C, 10D, 11A, 11B, 11C and 11D are exemplary screen diagrams illustrating in detail the simultaneous turning (namely, the foregoing operation 403) of a plurality of pages according to an exemplary embodiment.

Referring to FIGS. 9A and 9B, a display mode is a landscape mode, and the display unit 112 displays a first page 910 and a second page 920 in left and right sides of a screen under control of the controller 190. In this case, the display unit 112 may convexly display the second page 920. The display unit 112 may flatly display the second page 920 like the first page 910. The display unit 112 displays a first corner region 930 of the first page 910 and a second corner region 940 of the second page 920. In this case, the display unit 112 may display the second corner region 940 in an open state.

When a touch motion from a lower point 941 of the second corner region 940 to an inner side is detected, the controller 190 calculates the number of pages to be turned based on location information of a lower point 941. The location information may be center coordinates (X, Y) of a touched region. The controller 190 turns pages 950 corresponding to the calculated number to a left side at a time. For example, when a total page number of an e-book is 100 and a page number of the second page 920 is 51, the number of pages remaining in a right side of a screen is 50. The controller 190 confirms that the number of remaining pages is ‘50’ and then normalizes an X axis section of the second corner region 940 from 1 to 50. The controller 190 confirms that, for example, a normalization value matching with an X coordinate of the lower point 941 is 30. That is, since the page number of the second page 920 is 51, an X axis of the touched lower point 941 corresponds to a page number 80. As shown in FIGS. 9A, 9B, 9C, and 9D, a total of 30 pages corresponding to page numbers 51 to 80 are turned to a left side at once. As the 30 pages are turned to the left side, a third corner region 970 of the third page 960 displayed on the left side of the screen is displayed thicker than the first corner region 930. Remaining pages 81/100 in the fourth page 980 are displayed. For example, it may take 1.5 seconds to turn pages 950. A turning time may be set by the user. The turning time may be proportional to the number of pages to be turned. For instance, when the number of turned pages is in the range of 1 to 10, the turning time is 0.5 seconds. When the number of turned pages is in the range of 11 to 20, the turning time may be 1 second. When the number of turned pages is in the range of 20 to 40, the turning time may be 1.5 seconds. When the number of turned pages exceeds 40, the turning time may be 2 seconds. Alternatively, the turning time may be constant regardless of the number of pages to be turned. These turning times are exemplary only and many other turning times may alternatively be used.

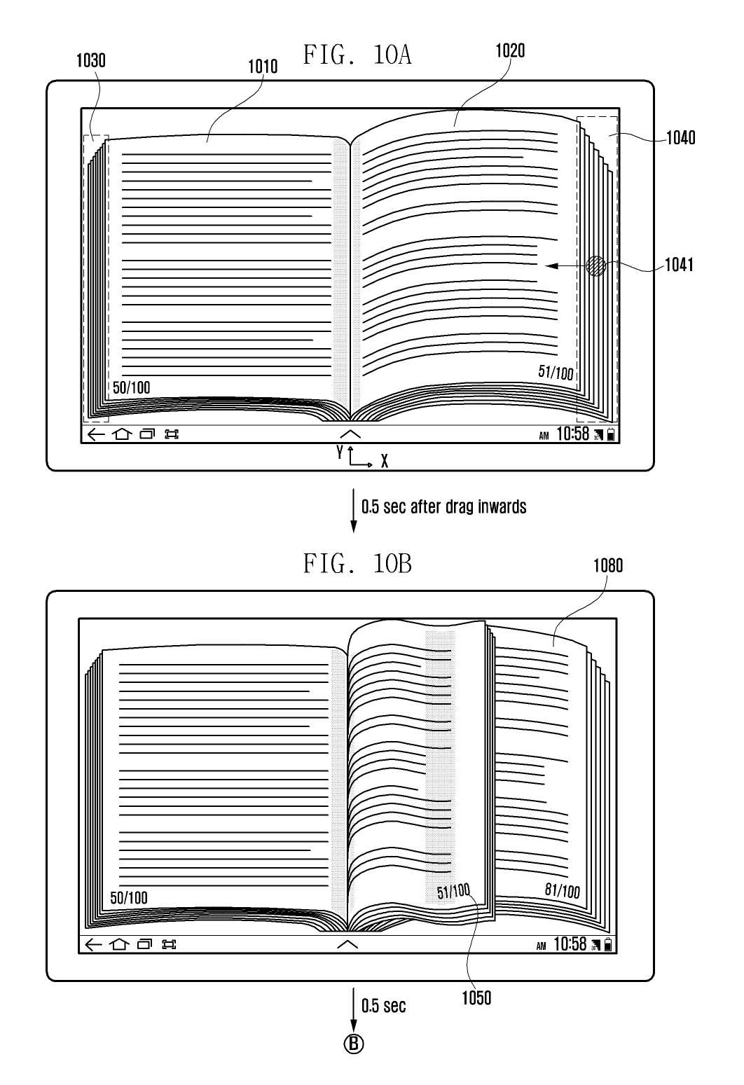

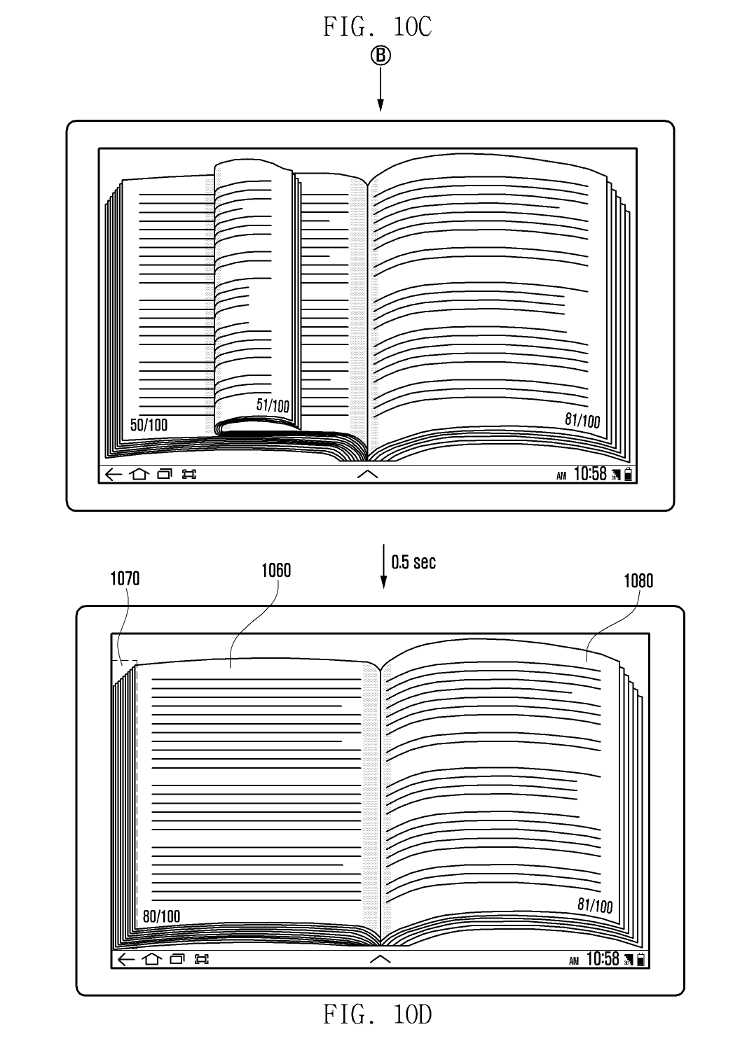

Referring to FIGS. 10A and 10B, a display mode is a landscape mode and the display unit 112 displays the first page 1010 and the second page 1020 in left and right sides of a screen, respectively. In this case, the display unit 112 may convexly display the second page 1020. The display unit 112 displays a first corner region 1030 of the first page 1010 and a second corner region 1040 of the second page 1020. In this case, the display unit 112 may display the second corner region 1040 in an open state.

When a touch motion from a central point 1041 of the second corner region 1040 to an inner side is detected, the controller 190 calculates the number of pages to be turned based on location information (e.g., X coordinate) of the central point 1041. The controller 190 turns pages 1050 corresponding to the calculated number to a left side at a time. For example, as shown in FIGS. 10B, 10C, and 10D, the controller 190 turns 30 pages to the left side at a time. As the 30 pages are turned to the left side, a third corner region 1070 of the third page 1060 displayed on the left side of the screen is displayed thicker than the first corner region 1030. Remaining pages 81/100 in the fourth page 1080 are displayed.

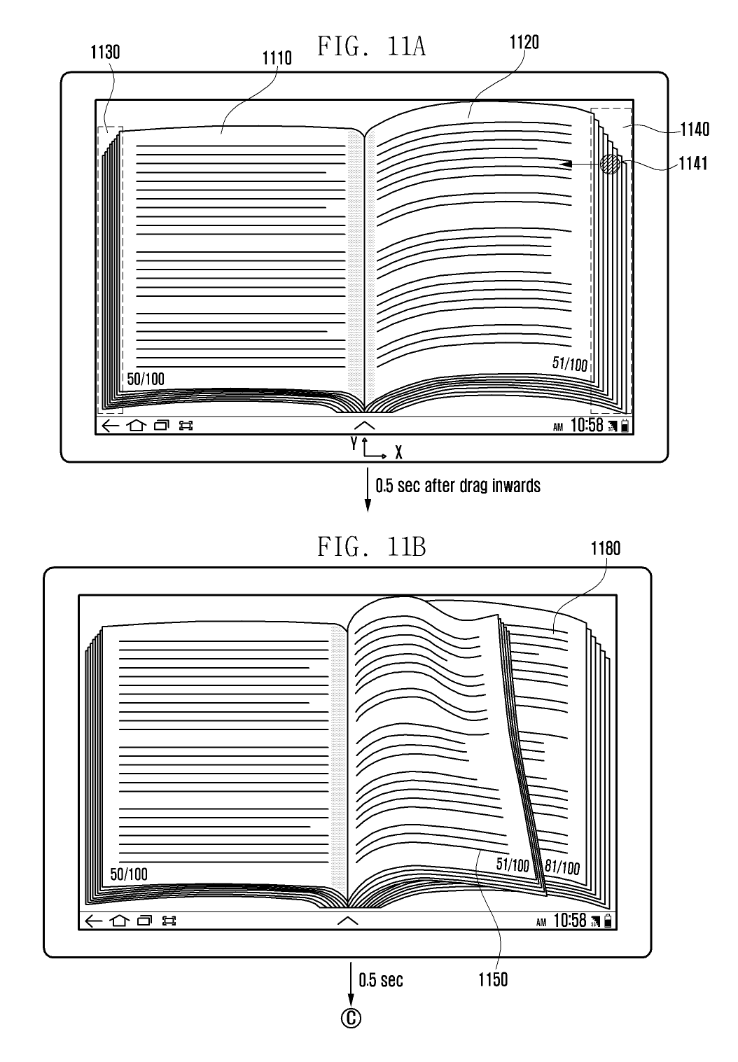

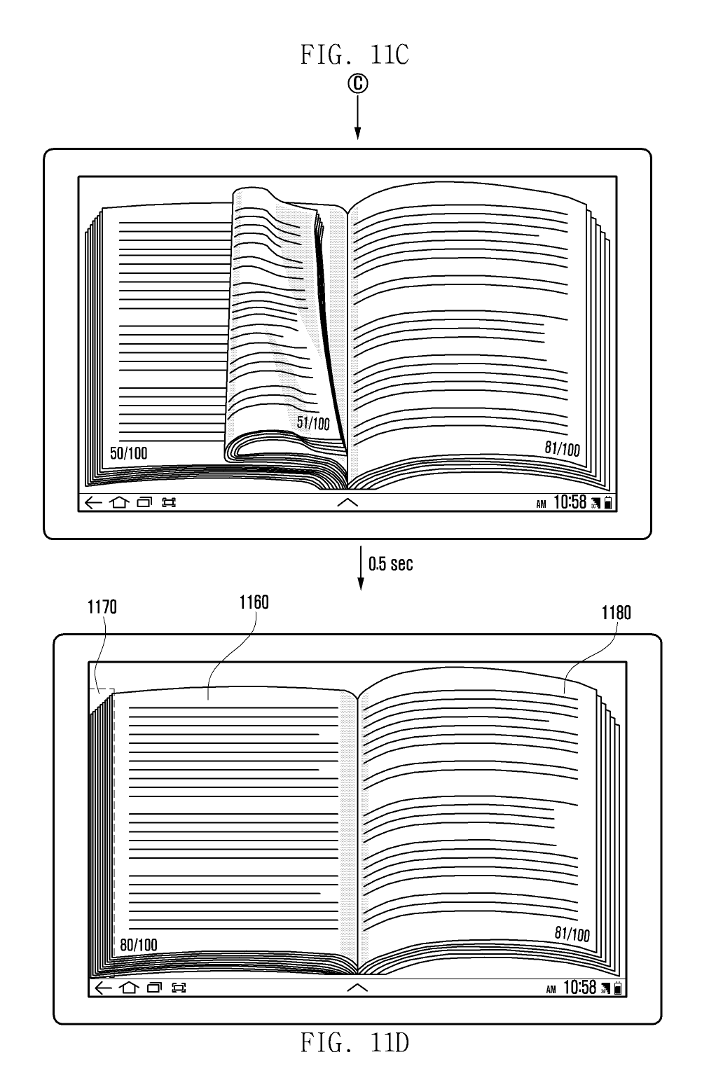

Referring to FIGS. 11A and 11B, a display mode is a landscape mode and the display unit 112 displays the first page 1110 and the second page 1120 in left and right sides of the screen. In this case, the display unit 112 may convexly display the second page 1120. The display unit 112 displays a first corner region 1130 of the first page 1110 and a second corner region 1140 of the second page 1120. In this case, the display unit 112 may display the second corner region 1140 in an open state. When a touch motion from an upper point 1141 of the second corner region 1140 to an inner side is detected, the controller 190 calculates the number of pages to be turned based on location information (e.g., X coordinate) of the upper point 1141. The controller 190 turns pages 1150 corresponding to the calculated number to a left side at a time. For example, as shown in FIGS. 11B, 11C, and 11D, the controller 190 turns 30 pages to the left side at a time. As the 30 pages are turned to the left side, a third corner region 1170 of the third page 1160 displayed on the left side of the screen is displayed thicker than the first corner region 1030. Remaining pages 81/100 in the fourth page 1180 are displayed.

As described above, upon comparing FIGS. 9A to 11D with each other, all turned pages are convex. However, it is understood that a shape of a transformed page may be changed according to the touch point. That is, as shown in FIGS. 9A, 9B, 9C and 9D, when a touch is moved from the lower point 941 to an inner side, the pages 950 are turned in such a fashion that a lower portion of the pages 950 is inclined toward the left side as compared with an upper portion thereof as would be the situation when turning pages in an actual paper book while holding a lower portion of a corner of the actual paper book. In contrast, as shown in FIGS. 10A, 10B, 10C and 10D, when the touch is moved from the central point 1041 to the inner side, the paper is uniformly turned without being inclined toward one direction. As shown in FIGS. 11A, 11B, 11C and 11D, when the touch is moved from the upper point 1141 to the inner side, the paper is turned such that upper portions of the pages 1150 are further inclined to the left as compared to lower portions thereof. The user may touch a touch input device in any point in a corner region in addition to the lower point 941, the central point 1041, and the upper point 1141 to move the paper to an inner side. As described above, the user may touch a corner region with the touch input device and move the paper to the inner side to turn a plurality of pages at a time. In this case, shapes of turned pages are changed according to a touched point in a corner region.

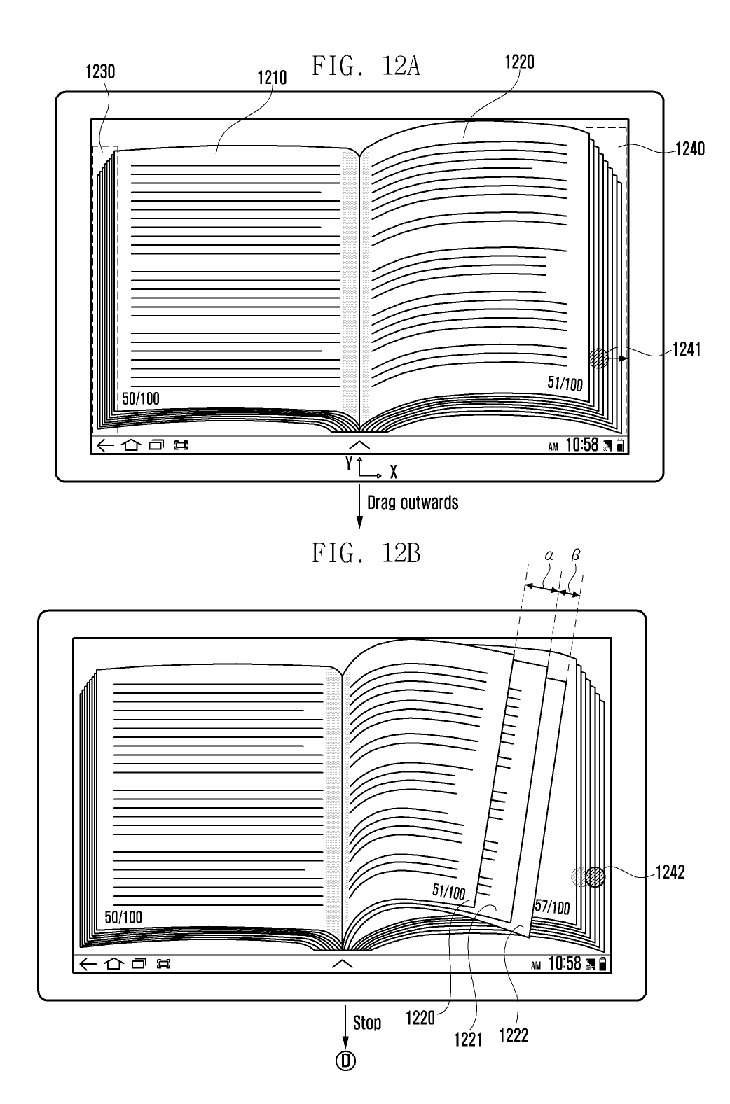

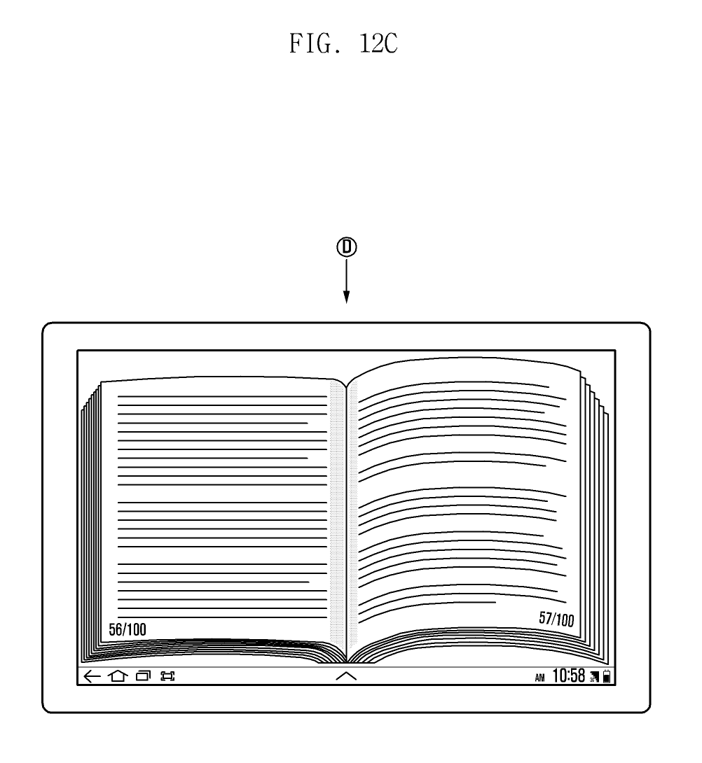

FIGS. 12A, 12B, 12C, 13A, 13B, 13C, 14A, 14B and 14C are exemplary screen diagrams illustrating in detail automatic momentary turning (namely, the forgoing operation 404) of pages according to an exemplary embodiment.

Referring to FIGS. 12A and 12B, a display mode is a landscape mode and the display unit 112 displays a first page 1210 and a second page 1220 in left and right sides under the control of the controller 190. The display unit 112 displays a first corner region 1230 of the first page 1210 and a second corner region 1240 of the second page 1220. When the user taps the second corner region 1240 of the second page 1220, the controller 190 convexly displays the second page 1220 and widely opens the second corner region 1240.

When a touch motion from a first lower point 1241 of the second corner region 1040 to an outer side (namely, direction opposite to inner side) is detected, the controller 190 sequentially pages one by one (or greater than one, for example, two by two) based on touch motion information. For example, as shown in FIG. 12B, the controller 190 sequentially turns the second page 1220, the third page 1221, and the fourth page 1222. When the second page 1220 is rapidly turned, an interval a between the second page 1220 and the third page 1221, which is the next page after the second page 1220, is great. When the third page 1221 is slowly turned, an interval β between the third page 1221 and the fourth page 122, which is the next page after the third page 1221, is narrow. The number of simultaneously turned pages may be set by the user. The touch motion information may include one of moving speed of a touch, a moving distance of the touch, and the number of remaining pages. For instance, when moving speed of the touch is high, the controller 190 may rapidly turn the pages. When the moving distance of the touch become longer, the controller 190 may rapidly turn the pages. When the number of remaining pages is reduced, the controller 190 may rapidly turn the pages. The touch motion information may include at least two of moving speed, a moving distance, and the number of remaining pages, although is not limited thereto. When the touch motion stops in a second lower point 1242, the controller 190 may stop page turning as shown in FIG. 12C. Turned shapes of the pages are changed according to a touched point, a moving direction of the touch, and speed of the touch, respectively.

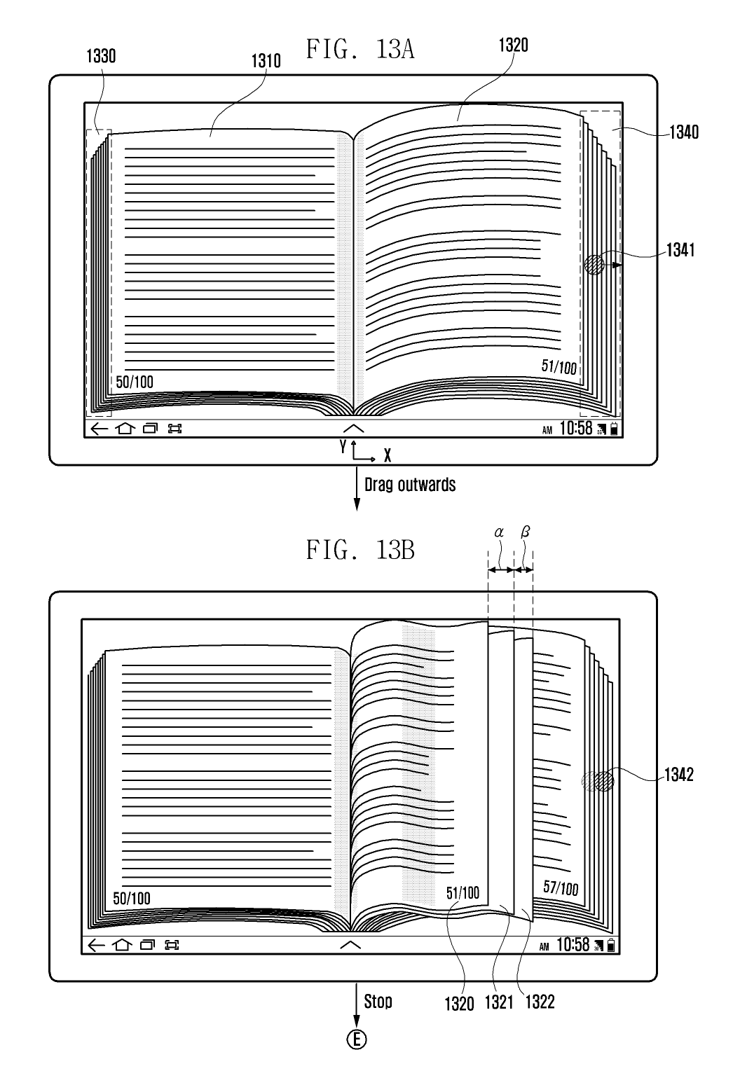

Referring to FIGS. 13A and 13B, a display mode is a landscape mode and the display unit 112 displays a first page 1310 and a second page 1320 on left and right sides. The display unit 112 displays a first corner region 1330 of the first page 1310 and a second corner region 1340 of the second page 1320. When the user of the display unit 112 taps the second corner region 1340 of the second page 1320, the controller 190 convexly displays the second page 1320 and widely opens the second corner region 1340 as shown in FIG. 13A.

When a touch motion from a first central point 1341 of the second corner region 1340 to an outer side is detected, the controller 190 sequentially pages one by one (or greater than one) based on touch motion information. For example, as shown in FIG. 13B, the controller 190 sequentially turns the second page 1320, the third page 1321, and the fourth page 1322. When the touch motion stops in the second central point 1342, the controller 190 may stop page turning as shown in FIG. 13C. Turned shapes of the pages are changed according to a touched point, a moving direction of the touch, and speed of the touch, respectively.

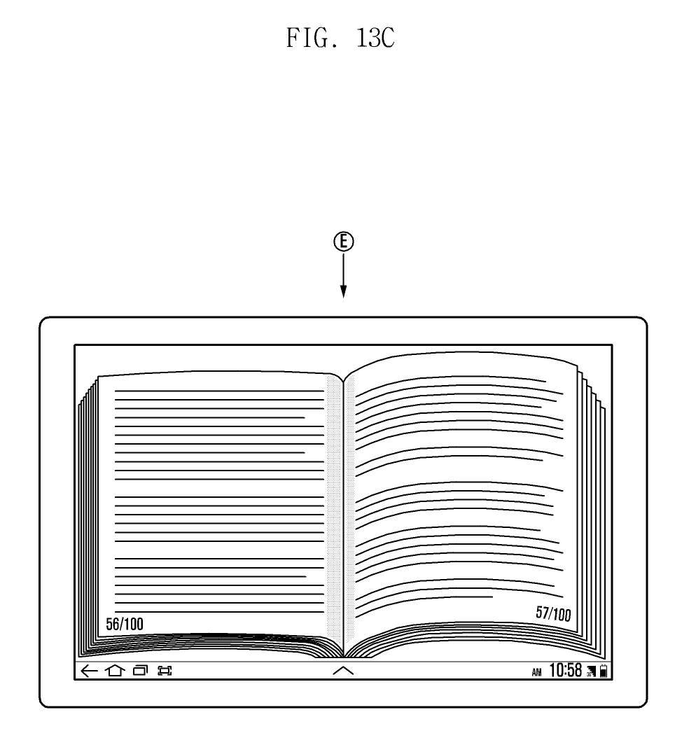

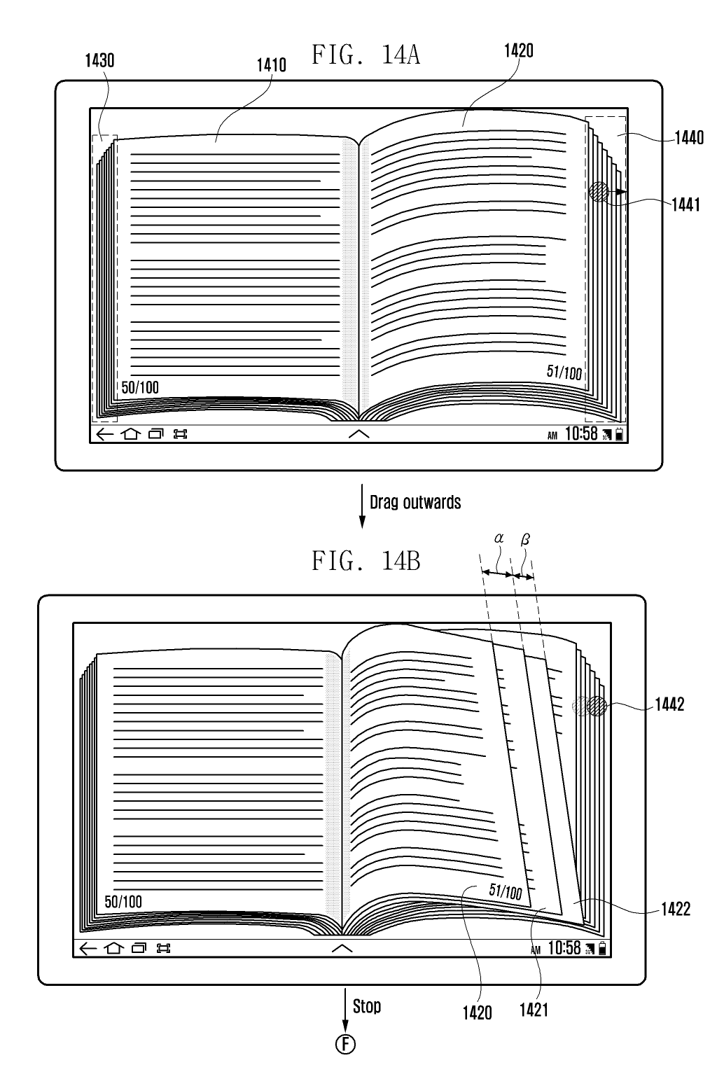

Referring to FIGS. 14A and 14B, a display mode is a landscape mode and the display unit 112 displays a first page 1410 and a second page 1420 on left and right sides. In this case, the display unit 112 may convexly display the second page 1420. The display unit 112 displays a first corner region 1430 of the first page 1410 and a second corner region 1440 of the second page 1420. In this case, the display unit 112 may display the second corner region 1440 in an open state.

When a touch motion from a first upper point 1441 of the second corner region 1440 to an outer side is detected, the controller 190 sequentially pages one by one (or greater than one) based on touch motion information. For instance, as shown in FIG. 14B, the controller 190 sequentially turns the second page 1420, the third page 1421, and the fourth page 1422. When the touch motion stops in the second upper point 1442, the controller 190 may stop page turning as shown in FIG. 14C. Turned shapes of the pages are changed according to a touched point, a moving direction of the touch, and speed of the touch, respectively.

As described above, upon comparing FIGS. 12A to 14C with each other, all turned pages are convex. However, it is understood that a shape of a transformed page may be changed according to the touch point. That is, as shown in FIGS. 12A, 12B and 12C, when a touch is moved from the first lower point 1241 to an outer side, the pages are turned in such a fashion that the lower portions of the second page 1220, the third page 1221, and the fourth page 1222 are inclined toward the left side as compared with the upper portions thereof, in the same way as flipping an actual paper while holding a lower portion of a corner of the actual paper book.

As shown in FIGS. 13A, 13B and 13C, when the touch is moved from the first central point 1341 to the outer side, the second page 1320, the third page 1321, and the fourth page 1322 are uniformly turned without being inclined toward one direction. As shown in FIGS. 14A, 14B and 14C, when the touch is moved from the first upper point 1441 to the outer side, upper portions of the second page 1420, the third page 1421, and the fourth page 1422 are turned while being further inclined towards the left than lower portions thereof. The user may touch a touch input device to any point in a corner region in addition to the foregoing first lower point 1241, the first central point 1341, and the first upper point 1441 to move the paper to an outer side. As described above, the user may touch a corner region with the touch input device and move the touch input device to the outer side to sequentially turn a plurality of pages. In this case, shapes of turned pages are changed according to a touched point in a corner region.

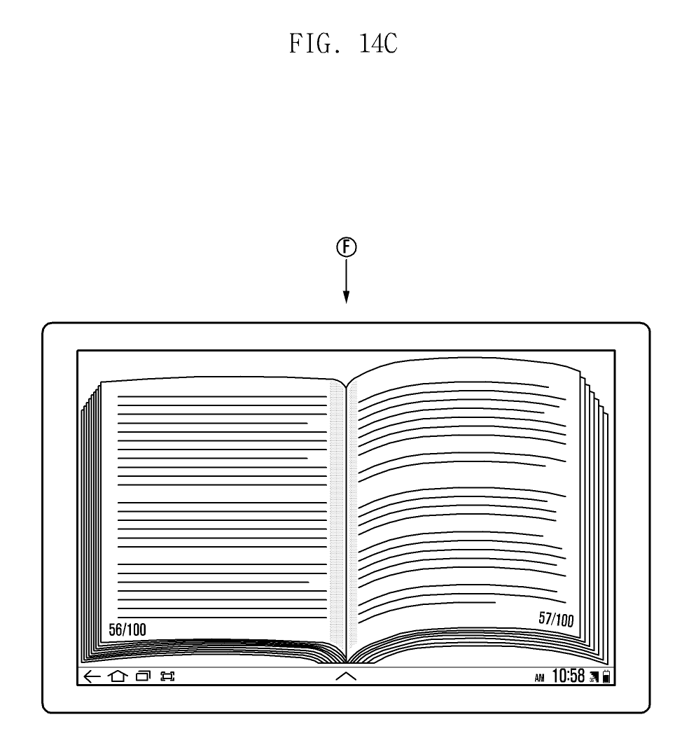

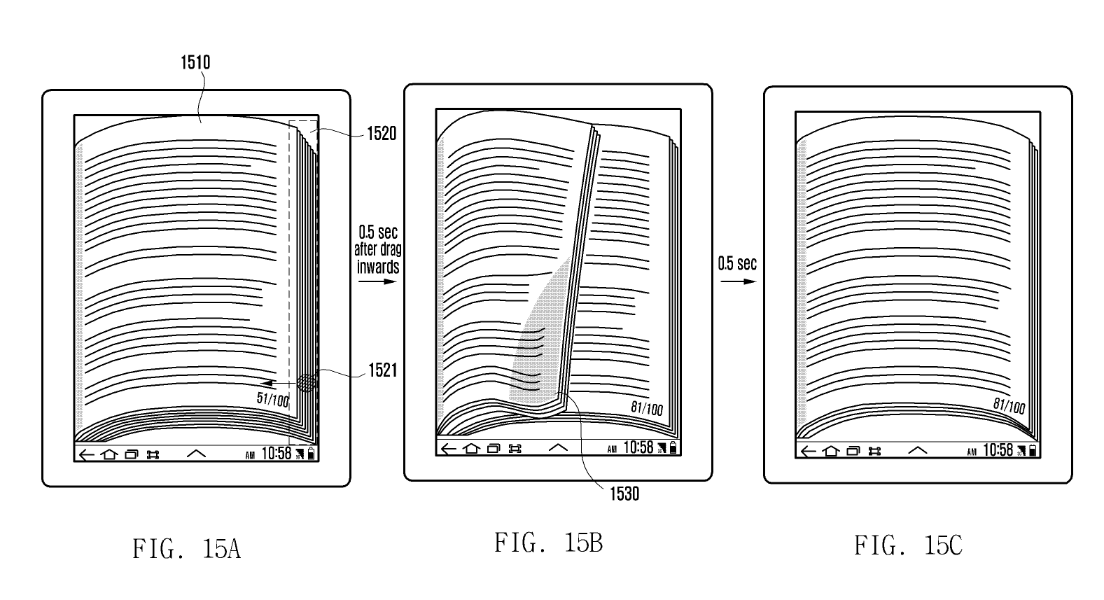

FIGS. 15A, 15B and 15C are exemplary screen diagrams illustrating in detail simultaneous turning of a plurality of pages according to another exemplary embodiment.

Referring to FIGS. 15A, 15B and 15C, a display mode is a portrait mode, and a display unit 112 convexly displays a first page 1510 under control of the controller 190. The display unit 1510 may flatly display the first page 1510. The display unit 112 displays a corner region 1520 of the first page 1510. When a touch motion from a lower point 1521 of the corner region 1520 to an inner side is detected, the controller 190 calculates the number of pages to be turned based on location information (e.g., X coordinate) of the lower point 1521. The controller 190 turns pages 1530 corresponding to the calculated number to the left side at a time. For example, as shown in FIGS. 15B and 15C, the controller 190 turns 30 pages to the left side at a time. In this case, shapes of pages to be turned are changed according to a point touched in a corner region.

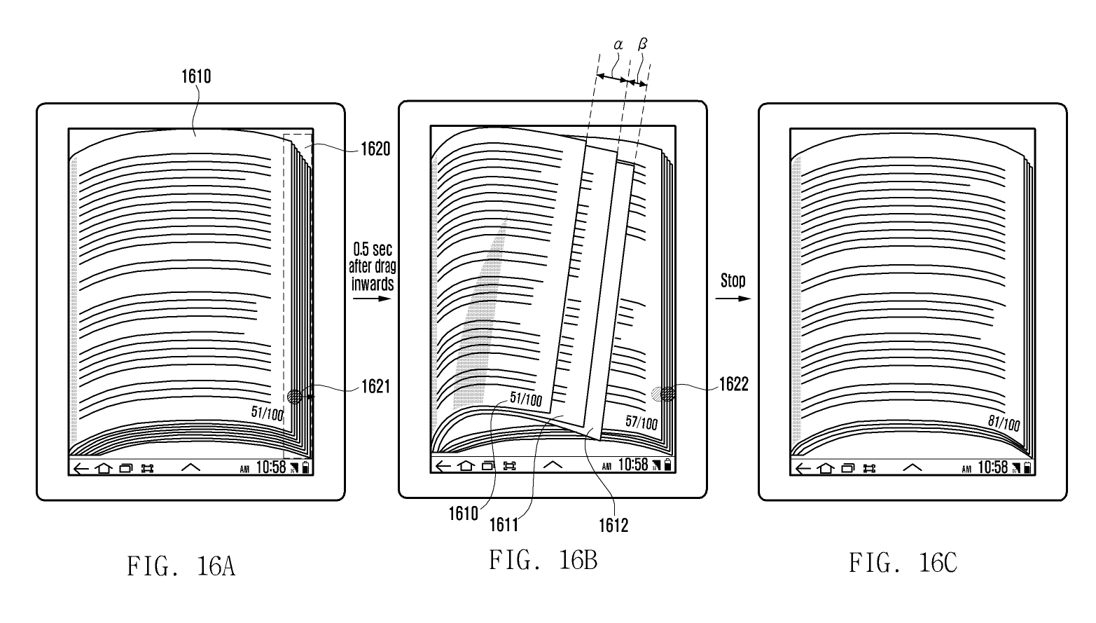

FIGS. 16A, 16B and 16C are exemplary screen diagrams illustrating in detail automatic momentary turning of pages according to another exemplary embodiment.

Referring to FIG. 16, a display mode is a portrait mode, and the display unit 112 convexly displays a first page 1610 under control of the controller 190. The display unit 112 displays a corner region 1620 of the first page 1610 in an open state. When a touch motion from a first lower point 1621 of the corner region 1620 to an outer side is detected, the controller 190 sequentially pages one by one (or greater than one) based on touch motion information. For example, as shown in FIG. 16(b), the controller 190 sequentially turns the first page 1610, the second page 1611, and the third page 1612. When the touch motion stops in the second lower pointer 1622, as shown in FIG. 16C, the controller 190 stops the page turning. Shapes of turned pages are changed according to a touched point in a corner region, respectively.

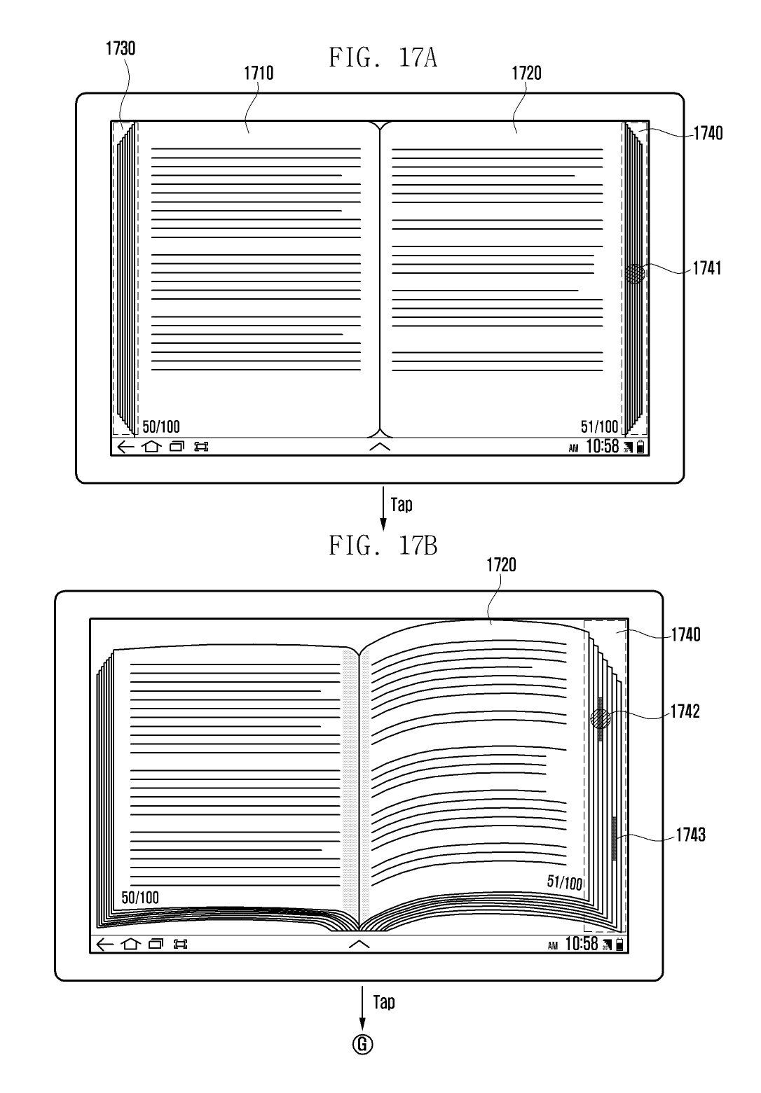

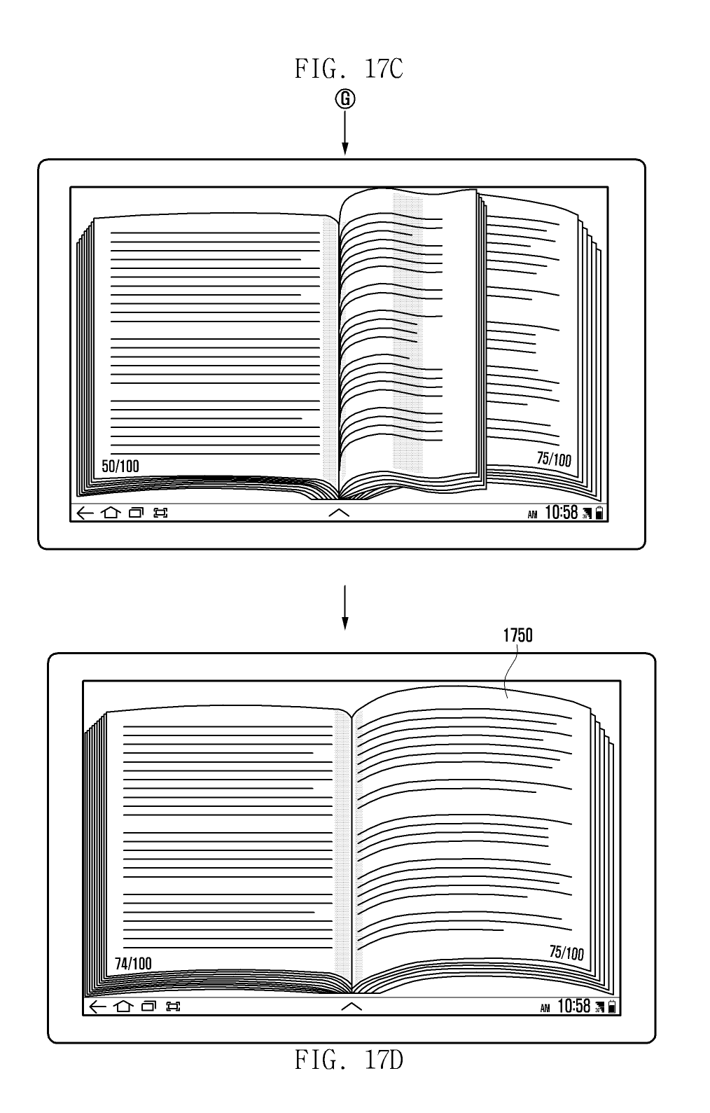

FIGS. 17A, 17B, 17C, and 17D are exemplary screen diagrams illustrating in detail simultaneous turning of a plurality of pages according to still another exemplary embodiment.

Referring to FIGS. 17A and 17B, a display mode is a landscape mode, and the display unit 112 displays a first page 1710 and a second page 1720 in left and right sides of a screen under control of the controller 190. The display unit 112 displays a first corner region 1730 in a left corner of the first page 1710. The display unit 112 displays a second corner region 1740 in a right corner of the second page 1720. When the user taps (1741) the second corner region 1740, as shown in FIG. 17B, the controller 190 widely opens the second corner region 1740. In this case, the display unit 112 may convexly display the second page 1720 under the control of the controller 190. The display unit 112 may display a tag, for example, a first tag 1742 and a second tag 1743 indicating user input information on the second open corner region 1740. That is, when the user taps (1741) a second corner region 1740, the controller 190 determines the specific page or pages in which user input information is inserted among the remaining pages. When there is a page in which the user input information is inserted, the controller 190 displays a tag indicating user input information corresponding to the page number on the second corner region 1740. The controller 190 displays a tag indicating user input information, for example, when the user has added user input information to two pages, the controller 190 displays two tags which include a first tag 1742 and a second tag 1743. The user input information may be many different types of information and may, for example, contain a memo, highlighted passages, images, bookmarks, or handwriting. That is, the first tag 1742 and the second tag 1743 may be information indicating a memo, highlighted passages, images, bookmarks, or handwriting.

When the user taps the first tag 1742, the controller 190 confirms a page corresponding to the first tag 1742. For example, when a page number of a first page 1720 displayed on a left side of a current screen is 51 and a page number of a confirmed page is 75, the controller 190 turns 24 pages (namely, 12 turn operations) all at once, as shown in FIG. 17C. Accordingly, as shown in FIG. 17D, the display unit 112 displays a third page 1750 corresponding to a page number 75 on a right side of the screen.

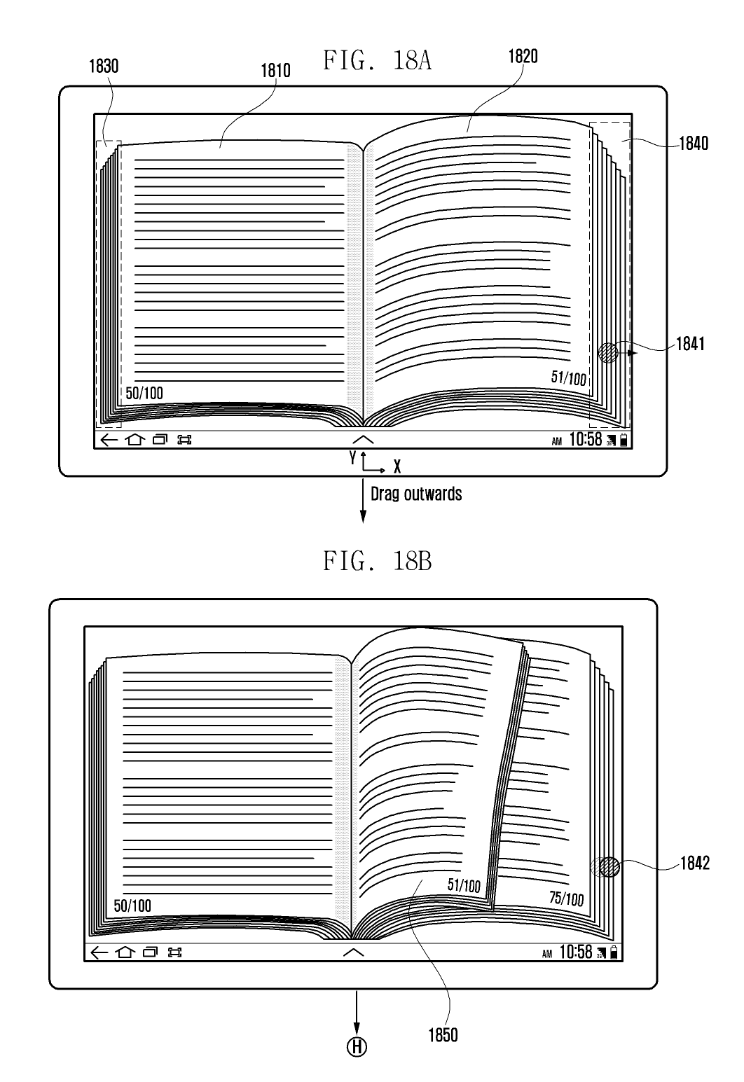

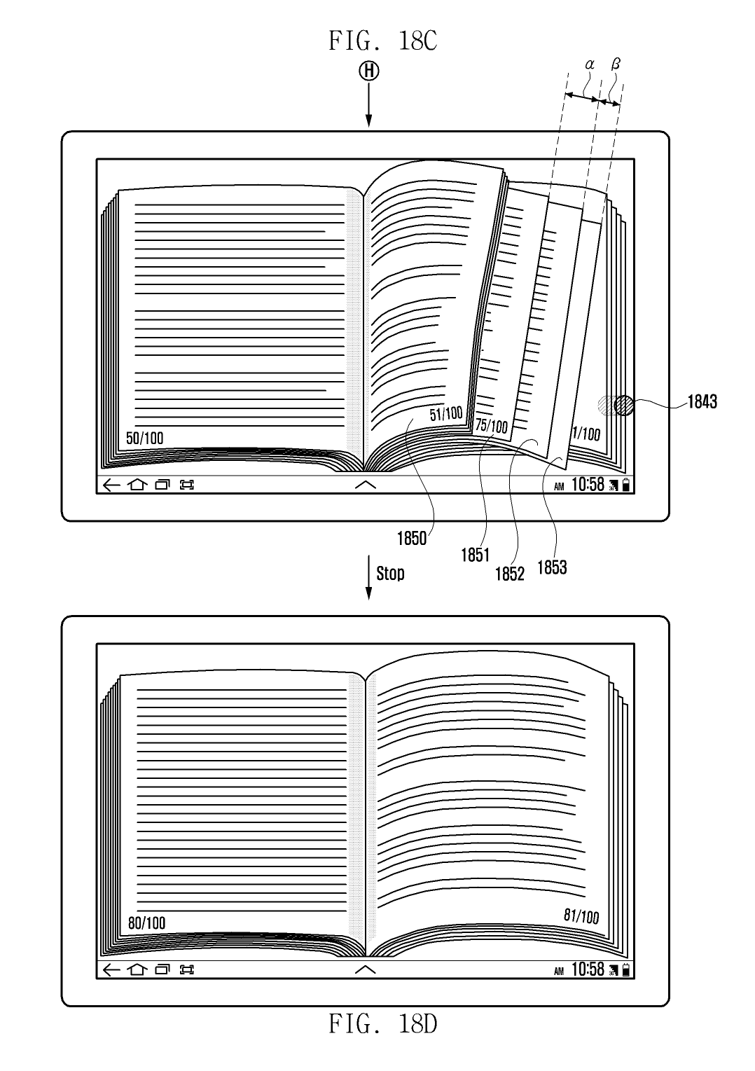

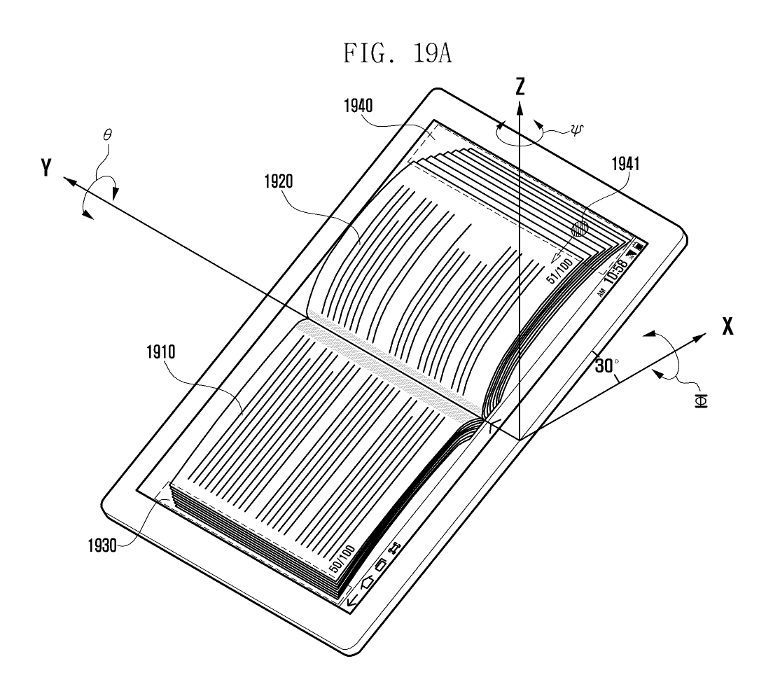

FIGS. 18A, 18B, 18C and 18D are exemplary screen diagrams illustrating in detail a method of turning pages according to another exemplary embodiment.

Referring to FIGS. 18A and 18B, a display unit 112 displays a first page 1810 and a second page 1820 on left and right sides of a screen under control of the controller 190. In this case, the display unit 112 may convexly display the second page 1820. Alternatively, the display unit 112 may flatly display the second page 1820 like the first page 1810. The display unit 112 displays a first corner region 1830 of the first page 1810 and a second corner region 1840 of the second page 1820. In this case, the display unit 112 may display the second corner region 1840 in an open state. When a touch motion from a first lower point 1841 of the second corner region 1840 to an outer side is detected, the controller 190 calculates the number of pages to be turned at a time based on location information of the first lower point 1841. An exemplary embodiment of a method of calculating the number of pages to be turned at a time has been described with reference to FIG. 9, and thus a detailed description thereof is omitted. The controller 190 turns pages 1850 corresponding to the calculated number to the left side at a time. The controller 190 detects a touch motion from a second lower point 1842 of the second corner region 1240 to an outer side. The controller 190 sequentially turns pages one by one (or greater than one, for example, two by two) in response to the detected touch motion. For example, as shown in FIG. 18C, the controller 190 sequentially turns the third page 1851, the fourth page 1852, and the fifth page 1853 among pages turning at a time. When the third page 1851 is rapidly turned, an interval a between the third page 1851 and a fourth page 1852 which is the next page after the third page 1851 is wide. When the fourth page 1852 is relatively and slowly turned, an interval β between the fourth page 1852 and a fifth page 1853 which is the next page after the fourth page 1852 is narrow. The number of simultaneously turned pages may be set by the user. The touch motion information may include one of moving speed of a touch, a moving distance of the touch, and the number of remaining pages. For instance, when the moving speed of the touch is high, the controller 190 may rapidly turn pages. When the moving distance becomes longer, the controller 190 may turn the pages. When the number of remaining pages is reduced, the controller 190 may rapidly turn the pages. The touch motion information may include at least two of moving speed, a moving distance, and the number of remaining pages. When the touch motion stops in the third lower point 1843, as shown in FIG. 18D, the controller 190 may stop page turning. According to exemplary embodiments, shapes of turned pages are changed according to a touched point, a moving direction of a touch, and speed of the touch.

FIGS. 19A and 19B are exemplary screen diagrams illustrating a method of turning pages according to still another exemplary embodiment. Referring to FIGS. 19A and 19B, in the portable terminal 100, a front portion of the portable terminal 100 in which the touch screen 110 is installed is oriented upward and a rear portion of the portable terminal 100 is oriented downward. For example, the user holds the portable terminal 100 with his or her hand. A display unit 112 displays a first page 1910 and a second page 1920 in left and right sides of a screen under control of the controller 190. The display unit 112 displays a first corner region 1930 of the first page 1910 and a second corner region 1940 of the second page 1920. The controller 190 computes a gradient of the portable terminal using acceleration information with respect to respective axes transferred from the sensor 185. For example, the controller 190 may compute a roll angle φ, a pitch angle θ, and a yaw angle ψ. In the case of a portable terminal shown in FIG. 19A, a computed gradient (φ, θ, ψ) of the portable terminal may be (0, 30, 0). When a touch motion from a lower point 1941 of the second corner region 1940 to an inner side is detected, the controller 190 calculates the number of pages to be turned based on location information of the lower point 1941. The controller 190 turns pages 1950 corresponding to the calculated number to the left side at a time. In this case, shapes of turned pages are changed according to detected touch information (e.g., a touched location, a moving distance, a moving direction, and speed). That is, the controller 190 computes a transformed degree of pages 1950 using detected touch information, convexly transforms the pages 1950 based on the transformed degree, and turns the transformed pages.

When computing the transformed degree, when the page turning mode is a merge mode, gradient information may be considered together with touch information. For example, as shown in FIG. 19B, when the portable terminal is inclined toward a turned direction of a page, the page may be rapidly turned. Although not shown, when the portable terminal is inclined to a direction opposite to the turned direction of the page, the page may be slowly turned. A gradient of the portable terminal may be smaller than a preset threshold gradient (e.g., −60°). In this state, when a touch motion occurs from a lower point 1941 of the second corner region 1940 to an inner side, pages 1950 may move and then return to an original location. When the page turning mode is a normal mode, the gradient information may not be considered in transforming the page. For convenience of description, the gradient information is limited to one axis, namely, a Y axis in FIGS. 19A and 19B. However, in general, a gradient of the portable terminal may be defined as “φ≠0, θ≠0, ψ≠0”. That is, three axes x, y, and z may be all inclined. In this case, the controller 190 may compute a convexly transformed degree of a page based on gradient information of all three axes. As described above, the gradient information may be considered in a case of turning pages one at a time, as well as a case of sequentially turning pages.

As shown in FIGS. 9A to 19B, a controller 190 according to exemplary embodiments may provide a shade effect to a folded part of a page. In detail, the controller 190 computes a normal vector in each coordinate of a page to process a folded part with a shade and calculates an angle between the normal vector and a light source vector orienting a light source. When the calculated value is less than a preset threshold (e.g., 10°), it is determined that the pages are directly receiving the light source so that the coordinates are processed brightly. Conversely, when the calculated value is greater than the preset threshold, it is determined that light from the light source does not reach certain portions of the pages, and as a result, coordinates of those portions are processed darkly. It may be assumed that the light source is located in a perpendicular line with respect to the page. Meanwhile, the controller 190 may process a dark degree by steps. For example, when the calculated value is greater than a first threshold (e.g., 10°) and less than a second threshold (e.g., 20°), the controller 190 processes corresponding coordinates at a first darkness level. When the calculated value is greater than the second threshold, the controller 190 may process the corresponding coordinates at a second darkness level which is darker than the first darkness level. Meanwhile, the shade effect may be achieved by various known technologies. Accordingly, the shade effect, which creates an impression that a page is in the shade, may be obtained by various other methods in addition to the foregoing method.

The foregoing method for turning pages in a portable terminal according to the exemplary embodiments may be implemented in an executable program command form by various computer devices and may be recorded in a computer readable recording medium. In this case, the computer readable recording medium may separately include a program command, a data file, and a data structure, or may include a combination thereof. In the meantime, the program command recorded in a recording medium may be specially designed or configured for the exemplary embodiments or be known to a person having ordinary skill in a computer software field. The computer readable recording medium includes Magnetic Media such as a hard disk, floppy disk, or magnetic tape, Optical Media such as a Compact Disc Read Only Memory (CD-ROM) or Digital Versatile Disc (DVD), Magneto-Optical Media such as a floptical disk, and a hardware device such as ROM, RAM, and flash memory storing and executing program commands. Further, the program command includes a machine language code created by a complier and a high-level language code executable by a computer using an interpreter. The foregoing hardware device may be configured to be operated as at least one software module to perform an operation of the exemplary embodiments.

As described above, in the method and the apparatus for turning pages according to the exemplary embodiments, the exemplary embodiments may provide a user with the feeling that the user is reading a paper book when the user reads an electronic book.

Although exemplary embodiments have been described in detail hereinabove, it should be clearly understood that many variations and modifications of the basic concepts disclosed herein may be understood by those skilled in the art and still fall within the spirit and scope of the exemplary embodiments, as defined in the appended claims.

What is claimed is:

1. A method of turning pages displayed on a portable terminal having a touch screen, the method comprising:
displaying a page of an electronic book on the touch screen;
detecting a touch in a first corner region of the page of the electronic book;
changing the first corner region into a second corner region in response to the touch;
detecting a continuous motion of the touch in the second corner region; and
turning the displayed page in response to the continuous motion of the touch.

2. The method of claim 1, wherein the turning of the displayed page comprises one of sequentially turning a plurality of pages by a predetermined number of pages per turn when a direction of the continuous motion of the touch is towards an outer side of the page, and turning the pages simultaneously when the direction of the continuous motion of the touch is towards an inner side of the page.

3. The method of claim 2, wherein the turning of the displayed page is performed until the continuous motion of the touch stops.

4. The method of claim 2, wherein the turning of the displayed page further comprises turning some pages simultaneously and then sequentially turning other pages by the predetermined number of pages per turn when the direction of the continuous motion of the touch is towards the outer side of the page.

5. The method of claim 1, wherein the second corner region is a region which is formed by transversely and widely opening the first corner region when the touch is detected from the first corner region.

6. The method of claim 1, wherein the displaying of the page of the electronic book comprises displaying a volume of pages corresponding to a number of remaining pages of the electronic book in the first corner region of the page.

7. The method of claim 1, wherein the turning of the displayed page comprises convexly changing the displayed page and turning the convexly changed page.

8. A method of turning pages displayed on a portable terminal having a touch screen, the method comprising:
displaying a page of an electronic book on the touch screen;
detecting a touch in a first corner region of the page of the electronic book;
transversely and widely opening the first corner region to thereby change the first corner region to a second corner region in response to the touch; and
displaying a tag in the second corner region.

9. The method of claim 8, further comprising turning at least one page to display a page corresponding to the tag in response to selection of the tag.

10. A method of turning pages displayed on a portable terminal having a touch screen, the method comprising:
displaying a page of an electronic book on the touch screen;
detecting a touch in a corner region of the displayed page of the electronic book;
detecting a direction of a continuous motion of the touch in the corner region; and
convexly changing the page and turning the convexly changed page in response to the detected direction of the continuous motion of the touch.

11. The method of claim 10, wherein the turning of the convexly changed page comprises one of sequentially turning a plurality of pages by a predetermined number of pages per turn when the detected direction is towards an outer side of the page, and turning the pages simultaneously when the detected direction is towards an inner side of the page.

12. A method of turning pages displayed on a portable terminal having a touch screen, the method comprising:
displaying a page of an electronic book on the touch screen;
detecting a touch in a first corner region of the page of the electronic book; and
changing the page such that the first corner region is changed into a second corner region in response to the touch,
wherein a predetermined region of the page changed to the second corner region is convexly transformed.

13. The method of claim 12, wherein the changing of the page comprises displaying a plurality of pages on the touch screen, comparing a page of the plurality of pages on which the touch is detected with other pages of the plurality of pages on which the touch is not detected, and more convexly transforming the page on which the touch is detected in comparison to the pages on which the touch is not detected.

14. The method of claim 12, wherein the page which is changed such that the first corner region is changed to the second corner region is a page on which a lower corner region is displayed.

15. A method of turning pages displayed on a portable terminal having a touch screen, the method comprising:
displaying a page of an electronic book on the touch screen;
detecting a touch in a corner region of the displayed page of the electronic book;
detecting a continuous motion of the touch in the corner region of the displayed page of the electronic book;
computing a gradient of the portable terminal; and
convexly transforming the page and turning the convexly transformed page in response to the detected continuous motion of the touch and the computed gradient.

16. An apparatus comprising:
a touch screen which displays a page of an electronic book; and
a controller which controls the touch screen,
wherein the controller opens a corner region of the page in response to a touch detected in the corner region of the page, detects continuous motion of the touch in the open corner region, and performs a control operation wherein the page is convexly transformed and the convexly transformed page is turned in response to the detected continuous motion of the touch.

17. The apparatus of claim 16, wherein the controller performs one of a control operation of sequentially turning a plurality of pages by a predetermined number of pages per turn when a direction of the continuous motion of the touch is towards an outer side of the page, and a control operation of turning the pages simultaneously when the direction of the continuous motion of the touch is towards an inner side of the page.

18. The apparatus of claim 16, wherein the controller performs a control operation wherein the corner region is transversely and widely opened and displayed when the touch is detected in the corner region.

19. The apparatus of claim 18, wherein the controller performs a control operation wherein a tag is displayed on the transversely and widely opened and displayed corner region.

20. A non-transitory computer readable recording medium implemented by a terminal having a touch screen, the non-transitory computer readable recording medium storing instructions which cause the terminal to perform the operations of:
displaying a page of an electronic book;
detecting a touch in a first corner region of the page of the electronic book;
changing the first corner region into a second corner region in response to the touch;
detecting a continuous motion of the touch in the second corner region; and
turning the displayed page in response to the continuous motion of the touch.
